(19) United States
(12) Patent Application Publication
(10) Pub. No.: US 2013/0267328 A1
(43) Pub. Date: Oct. 10, 2013

(54) SYSTEM AND METHOD FOR PROVIDING MOBILE SPORTS RELATED GAMES

(71) Applicant: Sports Technology Applications, Inc., Beverly Hills, CA (US)

(72) Inventors: Nathaniel Heisler, Los Angeles, CA (US); Richard Thurman, Malibu, CA (US); Jeffrey Scott Borris, Calabasas, CA (US); Daniel Beach, San Diego, CA (US)

(21) Appl. No.: 13/893,934

(22) Filed: May 14, 2013

Related U.S. Application Data
(63) Continuation-in-part of application No. 13/329,126, filed on Dec. 16, 2011.

(51) Int. Cl. A63F 13/12

(52) U.S. Cl. CPC A63F 13/12
USPC 463/42

(57) ABSTRACT

A method for providing a game comprises the steps of (i) communicating a first predicted outcome that is determined by a first user to a network via a first input device, the first predicted outcome relating to a future occurrence during a sporting event; and (ii) communicating an actual outcome of the occurrence from the network to the first input device substantially concurrently with the actual occurrence. Additionally, the method can further comprise evaluating the accuracy of the first predicted outcome with the network by comparing the first predicted outcome with the actual outcome; and communicating information regarding the accuracy of the first predicted outcome from the network to the first input device. Additionally, the method can further comprise the step of awarding benefits to the first user based on the accuracy of the first predicted outcome.

### RELATED APPLICATION

This application is a continuation-in-part of U.S. application Ser. No. 13/329,126 filed on Dec. 16, 2011, and entitled “SYSTEM AND METHOD FOR PROVIDING CONTESTS GAMES AND BENEFITS SHORTLY BEFORE, DURING AND SHORTLY AFTER A SPORTING EVENT EXCLUSIVELY FOR ATTENDEES OF THE SPORTING EVENT” which is currently pending. As far as is permitted, the contents of U.S. application Ser. No. 13/329,126 are incorporated herein by reference.

### BACKGROUND

During the past several decades, millions of individuals have participated in competitions that include the use and analysis of statistics that are generated during the playing of one or more sporting events. For example, the most common systems and methods for utilizing such statistics that are generated from sporting events involve fantasy sports leagues and related games and programs. In particular, these fantasy sports leagues typically involve people drafting real-life athletes of a specific sport to their virtual teams and playing those teams against other formulated virtual teams within a common virtual league. In these types of leagues, points are allocated or awarded based on how well each individual player on the virtual team's roster has performed, e.g., based on the compiling of certain specified real-life statistics, during one or more sporting events. Winners of these virtual leagues are then determined based on whose virtual teams performed the best over the course of an entire season.

Although the success of such fantasy sports leagues is undeniable, these fantasy sports leagues have been limited to competition within a virtual league rather than focusing on the performance of the individual participants at a single actual event (i.e. based on the performance of individual players and the outcomes of various events in real-time the game). Presently, no method or system allows users to compete in a game based on a live sporting event that provides various rewards or awards during the course of the game based on predictions by the users. Moreover, conventional systems and methods do not take advantage of the use of predictions by users regarding the outcome of certain in-game events, occurrences or contests. Additionally, such fantasy sports leagues typically require a lengthy commitment over the course of a sports season, as opposed to merely focusing on a single live event or even just a portion of such an event.

### SUMMARY

Recognizing the above-noted limitations of the presently available fantasy sports leagues, the present invention is directed toward a system and method that connects individual users or groups of users thereby forming a community that can be based solely on a single live event or only on one or more portions of such an event. The novel aspects of the present invention help to provide an interactive experience to the users where they can, through an input device, such as a mobile phone or otherwise, make selections regarding the event or item of potential interest and obtain unique prizes and provide other benefits and advantages desirable to the user. For example, in certain non-exclusive applications, the user can (i) make predictions regarding one or more players' performance during a sporting event or a portion of the sporting event, (ii) make predictions regarding the outcome of the sporting event or the outcome of certain individual plays that occur during the course of the sporting event, (iii) show support for a particular team, and/or (iv) comment on other users activity. Additionally, in some applications, the users who perform better, e.g., the users who score or are otherwise awarded more points during the sporting event in comparison to the other users, can receive one or more prizes or other incentives. In some such applications, users can receive real and/or virtual cash, merchandise, tickets, coupons, the ability to meet players/sponsors/celebrities or other performers, and/or other prizes or incentives. Further, those users that perform better than other users may also be given the ability to be recognized for their superior performance by, for example, showing their image, name and/or performance to other users.

In one application, the present invention is directed toward a method for providing a game, the method comprising the steps of (i) communicating a first predicted outcome that is determined by a first user to a network via a first input device, the first predicted outcome relating to a future occurrence during a sporting event; and (ii) once the future occurrence has occurred, communicating an actual outcome of the occurrence from the network to the first input device substantially concurrently with the actual outcome of the occurrence.

In some embodiments, the method further comprises the step of evaluating the accuracy of the first predicted outcome with the network by comparing the first predicted outcome with the actual outcome. In one such embodiment, the method can further comprise the step of communicating information regarding the accuracy of the first predicted outcome from the network to the first input device. Additionally and/or alternatively, the method can further comprise the step of awarding benefits to the first user based on the accuracy of the first predicted outcome. In some such embodiments, the step of awarding benefits includes awarding points to the first user based on the accuracy of the first predicted outcome for use in a competition against a second user. Additionally, in one such embodiment, the first user and the second user are actual attendees at the sporting event. Further, in one embodiment, the step of awarding benefits can include correlating the benefits to be awarded to actuarial data regarding the probability that the first predicted outcome will occur.

Additionally, in certain embodiments, the first predicted outcome can relate to an individual occurrence during the course of the sporting event. For example, in one such embodiment, the individual occurrence can be a pitch during a baseball game, and the first predicted outcome can include one of a location, a type and a speed of the pitch.

In one embodiment, the method further comprises the step of the network querying the first user via the first input device with respect to the future occurrence prior to the step of communicating the first predicted outcome that is determined by the first user to the network via the first input device.

Further, in some embodiments, the first input device can be one of a mobile phone, a tablet, a laptop computer, a kiosk and a desktop computer.

Additionally, in another application, the present invention is further directed toward a method for providing a game, the method comprising the steps of (i) communicating a first predicted outcome that is determined by a first user to a network via a first input device, the first predicted outcome relating to a future occurrence during a sporting event; (ii) once the future occurrence has occurred, evaluating the accuracy of the first predicted outcome with the network by comparing the first predicted outcome with an actual outcome of the occurrence; and (iii) awarding benefits to the first user via the network based on the accuracy of the first predicted outcome.

Further, in still another application, the present invention is directed toward a method for providing a game, the method comprising the steps of (i) querying a first user with respect to a future occurrence in a sporting event via a first input device with a network; (ii) communicating a first predicted outcome that is determined by the first user to the network via the first input device, the first predicted outcome relating to the future occurrence in the sporting event; (iii) once the future occurrence has occurred, communicating an actual outcome of the occurrence from the network to the first input device substantially concurrently with the actual outcome of the occurrence; (iv) evaluating the accuracy of the first predicted outcome with the network by comparing the first predicted outcome with the actual outcome; (v) communicating information regarding the accuracy of the first predicted outcome to the first input device with the network; and (vi) awarding points to the first user via the network based on the accuracy of the first predicted outcome for use in a competition against a second user.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a simplified schematic illustration of a network system and method having features of the present invention;

FIG. 1B is a simplified schematic illustration depicting a plurality of modules that can be incorporated within the network system and method of FIG. 1A;

FIG. 2 is a simplified schematic illustration of a startup menu usable with the network system and method illustrated in FIG. 1A;

FIG. 3 is a simplified schematic illustration depicting a display for a user to establish and/or amend user-supplied profile information;

FIG. 4 is a simplified schematic illustration depicting a display for the user to access a “Register” interface, in which the user can register their information with the network system;

FIG. 5 is a simplified schematic illustration depicting a display of a main menu that may be included with the network system in FIG. 1A;

FIG. 6 is a simplified schematic illustration depicting a display for the user to access and customize an “Application Settings” interface;

FIG. 7A is a simplified schematic illustration depicting a display for a “Legal” interface that may be included as part of the present invention;

FIG. 7B is a simplified schematic illustration depicting a display for a “Rules” interface that may be included as part of the present invention;

FIG. 8 is a simplified schematic illustration depicting the selection of the stadium, ballpark or arena at which a sporting event is or will occur with which the present invention can be used;

FIG. 9A is a simplified schematic illustration of an embodiment of a pre-game picks page depicting certain pre-game picks that users may select in relation a baseball game;

FIG. 9B is a simplified schematic illustration of another embodiment of a pre-game picks page depicting certain pre-game picks that users may select in relation a baseball game;

FIG. 9C is a simplified schematic illustration of still another embodiment of a pre-game picks page depicting certain pre-game picks that users may select in relation a baseball game;

FIG. 9D is a simplified schematic illustration of an embodiment of an in-game picks page depicting certain in-game picks that users may select in relation a baseball game;

FIG. 9E is a simplified schematic illustration of another embodiment of an in-game picks page depicting certain in-game picks that users may select in relation a baseball game;

FIG. 9F is a simplified schematic illustration of still another embodiment of an in-game picks page depicting certain in-game picks that users may select in relation a baseball game;

FIGS. 9G-9K are alternative simplified screen shots illustrating embodiments of a pitch selection interface for a baseball game that can be incorporated within the network system and method in FIG. 1A;

FIGS. 9L-9S are alternative simplified screen shots illustrating embodiments of a managerial selection interface for a baseball game that can be incorporated within the network system and method in FIG. 1A;

FIG. 10A is a simplified schematic illustration of another embodiment of a pre-game picks page depicting certain pre-game picks that users may select in relation to a basketball game;

FIG. 10B is a simplified schematic illustration of another embodiment of an in-game picks page depicting certain in-game picks that users may select in relation to a basketball game;

FIG. 11A is a simplified schematic illustration of another embodiment of a pre-game picks page depicting certain pre-game picks that users may select in relation to an American football game;

FIG. 11B is a simplified schematic illustration of another embodiment of an n-game picks page depicting certain in-game picks that users may select in relation to an American football game;

FIG. 12A is a simplified schematic illustration of another embodiment of a pre-game picks page depicting certain pre-game picks that users may select in relation to a football (soccer) match;

FIG. 12B is a simplified schematic illustration of another embodiment of an in-game picks page depicting certain in-game picks that users may select in relation to a football (soccer) match;

FIG. 13A is a simplified schematic illustration of another embodiment of a pre game picks page depicting certain pre-game picks that users may select in relation to a hockey game;

FIG. 13B is a simplified schematic illustration of another embodiment of an in-game picks page depicting certain in-game picks that users may select in relation to a hockey game;

FIG. 14A is a simplified schematic illustration of another embodiment of a pre-game picks page depicting certain pre-game picks that users may select in relation to a golf tournament;

FIG. 14B is a simplified schematic illustration of another embodiment of an in-game picks page depicting certain in-game picks that users may select in relation to a golf tournament;

FIG. 15A is a simplified schematic illustration of an embodiment of a viewable “Game Status” interface, which includes a display of the current point allocation for the user;

FIG. 15B is a simplified schematic illustration depicting a leaderboard interface for displaying the current standings or rankings of the users;

FIG. 16 is a simplified schematic illustration depicting an embodiment of a game prizes interface showing the viewable game prizes that may be won by any participating user or viewer;

FIG. 17A is a simplified screen shot of an embodiment of a virtual locker that can be incorporated within the network system and method in FIG. 1A;

FIG. 17B is a simplified screen shot of another embodiment of a virtual locker that can be incorporated within the network system and method in FIG. 1A; and

FIG. 18 is a simplified schematic illustration of an order interface which gives users the ability to order food, souvenirs, and other items from their seat using the present invention.

### DESCRIPTION

As provided in detail herein, the present disclosure relates to a system and method for providing a network interface which can be accessed on an input device, e.g., a mobile phone, tablet, laptop computer, kiosk, desktop computer, or other suitable input device. The network interface provides a user with the ability to connect with other users, such as via an online network, to create an exclusive community of users who are attending or otherwise following an event. It should be noted that the systems and methods of the present invention can be used along with any event, sporting or otherwise, and includes but is not limited to, golf, hockey, football, basketball, baseball, soccer, boxing, mixed martial arts (MMA), all different types of motorsports, swimming, water polo, skiing, snowboarding, bowling, Olympic sporting events, horseracing, tennis, rugby, gambling, volleyball and cricket, as well as any other suitable sport or event. Stated in another manner, the event can be any event that a user would want to see, follow or actually participate in. Additionally, it should be further noted that the present invention can be used with live events, and the output of the systems and methods of the present invention can be provided and/or updated substantially in real-time. As used herein, the term “real-time” or “substantially in real-time” means substantially concurrently, and includes not only the actual time during which a process or event occurs, but also may include a slight delay that is basically imperceptible to the user, which may be on the order of a few seconds or less. Further, it is recognized that although the present application is written primarily with respect to the use of the present invention at one or more sporting events, the system and method disclosed herein can be equally used at various non-sporting events.

In certain embodiments, the system and method can be practiced using a mobile device, such as a mobile phone or tablet device. In one such embodiment, the application operates off of the Apple® iPhone® and is written using Objective C (Coco development). However, it should be noted that the present invention is adaptable for use on any operating system, including, but not limited to, Java, OSX, HTML/Javascript, Linux®, or any other suitable operating system, using any known code.

During use in relation to a sporting event, the application of the present invention can allow users to interact with one another, and to make selections or predictions regarding the players in the sporting event, other in-game events, and/or the outcome of the sporting event or any portions thereof. In turn, users may be eligible to receive real or virtual awards or prizes, or exclusive content based on the accuracy of their predictions. For example, in various embodiments, the potential awards or prizes can include, but are not limited to, real or virtual cash, points, prizes, discounts, coupons, incentives, tickets, targeted advertising, or promotional materials. Additionally, in certain embodiments, the present invention enables users to participate in competitions against other users in order to be eligible for various special offers and prizes. This can help to provide the users with a better, more enjoyable experience of the sporting event, with the results and output of the competitions occurring at least substantially in real-time.

Additionally, in one non-exclusive embodiment, the application is free for download by users with the option to pay a relatively modest fee to remove advertising from the application.

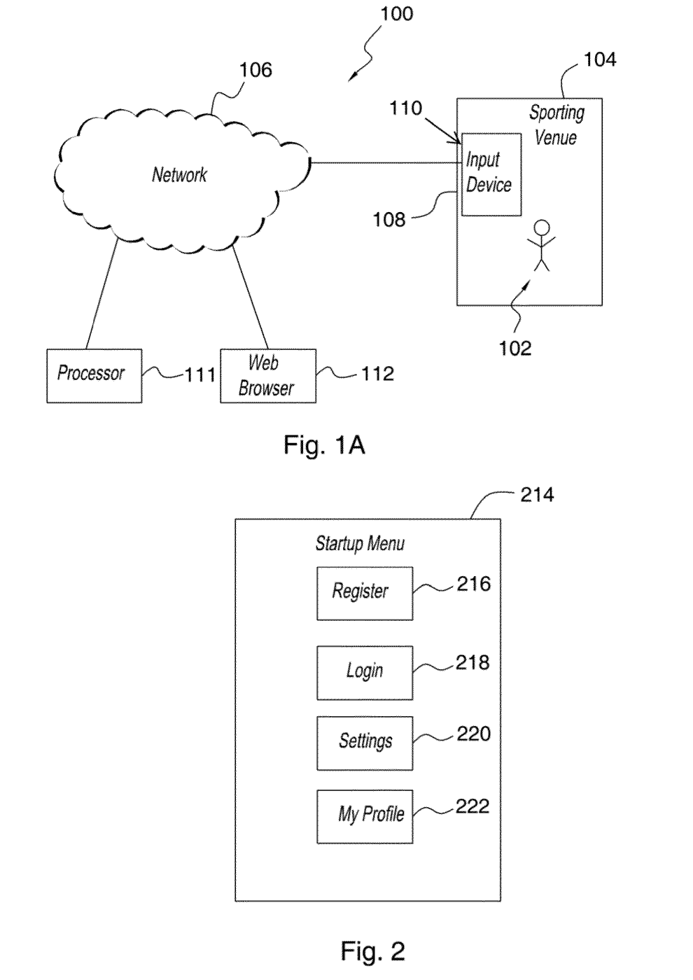

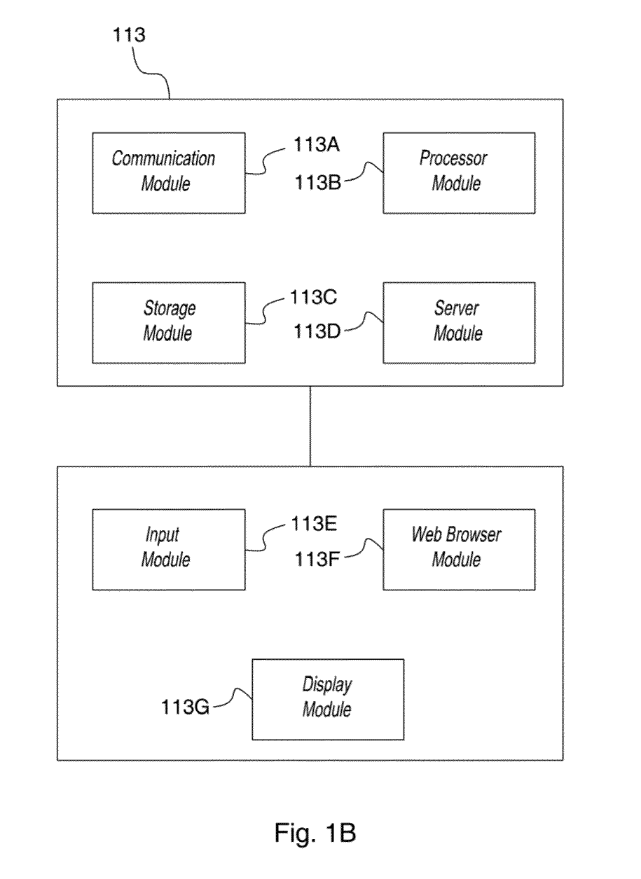

FIG. 1A is a simplified schematic illustration of a network system and method 100 (also sometimes referred to herein simply as a “network system”), including one or more users 102 (only one is illustrated in FIG. 1A), which can be actual attendees at an event, e.g., a live sporting event, and/or virtual attendees at the event who are following the progress of the event at a location other than the actual location of the event.

Additionally, FIG. 1A further illustrates the user 102 being present at and/or within a sporting venue 104, e.g., a stadium, ballpark, arena, or other appropriate sporting venue, at which the sporting event is taking place. In one embodiment, in the case of the user 102 being an actual attendee at the sporting event, the sporting venue 104 can be the actual sporting venue at which the sporting event is or will be occurring. In one embodiment, users 102 who are actual attendees at the sporting event can create a community with and among other users 102 who are also actual attendees at the sporting event.

Additionally and/or alternatively, in the case of the user 102 being a virtual attendee at the sporting event, the sporting venue 104 can be a virtual sporting venue that is merely representative of the actual sporting venue at which the sporting event is or will be occurring. In such applications, the network system 100 can further allow the user 102 to create a virtual sporting venue for the sporting event, where the user 102 can select his or her seat at the sporting venue 104 along with other users 102 and cheer for the team and/or players that he or she is supporting. Additionally, the virtual sporting venue can be utilized to enable the user 102, i.e. the virtual attendee, to interact with and/or compete against other users 102, i.e. other virtual attendees and/or actual attendees. Thus, the users 102 in any given competition utilizing the network system 100 can include one or more actual attendees at the sporting event and/or one or more virtual attendees at the sporting event.

With the various network systems 100 described herein, the users 102 can be provided with a more enjoyable and/or interactive experience of the sporting event since it allows the users 102 to interact with and/or compete against one another thereby forming a community amongst the users 102. The network system 100 can also allow the users 102 to more greatly appreciate and enjoy the benefits and advantages of the sporting venue 104. Further, in one embodiment, the network system 100 allows the users 102 to communicate with other users 102 of the network system 100 who are or may be actual attendees or virtual attendees of the same sporting event. The means of communication can include, but are not limited to, text messages, online chat messages, etc.

As further shown in FIG. 1A, the user 102 can access a network 100, e.g., a network server, setup by the system and method using an input device 108 and a game application 110 (also referred to herein simply as an “application”) that can be accessed via the input device 108. As noted above, a suitable input device 108 for using the network system 100 and/or the application 110 can include a mobile phone, tablet, laptop computer, kiosk, desktop computer, or other suitable input device.

In one embodiment, when the application 110 starts for each individual use, the application 110 determines whether this is the first time the application 110 has been used by this particular user 102 and/or on this particular input device 108, or whether the application 110 has been used before. If this is the first time the application is being so used, then the user 102 is requested to register with the network 106. The user 102 can register with the network 106 in any suitable manner. For example, in one embodiment, the user 102 can register with the network 106 by supplying his or her email address and a password or other suitable login information to the network 106, either directly or from a third-party service such as Facebook® or Twitter®, via the input device 108 and the application 110. In one aspect of at least one embodiment of the present invention, when the application 110 is registered for an individual user 102, the local CoreData services store a copy of the token and authentication IDs in order to allow easy verification later. Thus, if the user 102 chooses to login during any subsequent uses of the application 110, the user 102 simply has to enter the email and password or other login information that was specified during the initial run. Several field verifiers are in place to sanitize the information as it is passed from the user 102 to the network 106, i.e. the network server.

After the user 102 fills out the required information for use of the application 110, as well as any additional optional information that may be provided, the input device 108 sends a POST request to the network server 106. The preceding information can be encoded using JSON and the file as a multipart attachment. The network server 106 then parses the results, stores the file, and returns the new userID to the user 102. At the same time, JSON-encrypted updates are also delivered to the input device 108. The updates correspond to each version of information contained within the application 110 (e.g., team information, player information, game status, etc.).

After successful login/registration, the user 102 is then eligible to participate in one or more selected competitions via the input device 108. It should be noted that, in certain embodiments, each subsequent use of the application 110 by an individual user 102 can be through use of the original input device 108 or another suitable input device 108, provided the necessary verification information is provided by the user 102.

As illustrated in FIG. 1A, the network system 100 further comprises a processor 111 that allows eligible users 102 to use the interactive game interface, i.e. the application 110, to make predictions as to the outcomes of various aspects of the sporting event and performance of individual players. In order to do this, the input device 108 must acquire information about the particular sporting event that is being predicted. In one aspect of at least one embodiment, the input device 108 accomplishes this by sending out a request to the network server 106 that looks up the location and time of the input device 108 and returns the sporting event that matches the information provided in the request. The network server 106 will then cross reference the deviceID+time+token and return with the current game information, including: Stadium Information, Team Information, Player Information, and Game Information, All the aforementioned information is bundled in a JSON response which is then converted into a NSDictionary object for easier handling.

It should be appreciated that it is within the scope of the present invention to replace the deviceID+time+token arrangement by a bluetooth-based APN verification at a concession stand or other location at or near the sporting venue 104. This will require the input device 108 to activate itself, thus disclosing the location of the user 102 and acquiring the aforementioned game information. Like the deviceID+time+token system, the BluetoothAPN PIN+deviceID combination will also return with the current game information (i.e. Stadium Information, Team Information, Player Information, and Game Information), which will also all be bundled in a JSON response which is then converted into a NSDictionary object for easier handling.

Further, it should also be appreciated that it is within the scope of the present invention to replace the deivceID+time+token arrangement by a NFC (Near Field Communication) system at a concession stand or other location at or near the sporting venue 104. The NFC system allows connecting of input devices 108 located in certain range allowing users 102 to access the application 110 from their NFC enabled input device 108. Each user's NFC system has unique RFID disclosing the location of the user 102 and acquiring the aforementioned game information. Like the deviceID+time+token system, the NFC+deviceID combination will also return with the current game information (i.e. Stadium Information, Team Information, Player Information, and Game Information), which will also all be bundled in a BISON response which is then converted into a NSDictionary object for easier handling.

While using the network system 100 of the present invention, the users 102 also have the ability connect to the web via an online web browser 112 that may be present within the input device 108. Another beneficial aspect of the network system 100 of the present disclosure is that it allows the users 102 to become more involved with the sporting event and other users 102 and prove their knowledge of teams, players, games, strategies, etc. against other users 102 and receive benefits and advantages while doing so.

FIG. 1B is a simplified schematic illustration depicting a plurality of modules 113 that can be incorporated within the network system 100 of FIG. 1A. In particular, FIG. 1B illustrates one embodiment that depicts how each of the individual modules 113 can work together within the network system 100. For example, the network system 100 can include a communications module 113A that works in accordance with a processor module 113B and allows the users 102 (illustrated in FIG. 1A) to connect to the network system 100 and the network 106 (illustrated in FIG. 1A) using their input devices 108 (illustrated in FIG. 1A). Additionally, a storage module 113C can also be connected so that information can be stored to, a server module 1130, which is connected under the same network 106.

Each user's input device 108 will allow the network system 100 to connect an input module 113E to the network 106 and allow access to the internet via a web browser module 113F provided within the input device 108. It should be noted that the input device 108 operates in a similar manner as described herein above. The input device 108 can further include a display module 113E that enables the user 102 to view and utilize the systems and methods described herein. For example, the network system 100 of this present disclosure allows for the user 102 to constantly check their game status, which can be found among the options available on a main menu 548 (such as illustrated in FIG. 5).

In yet another aspect of the present invention, one or more of the plurality modules 113 of the network system 100 can include and/or incorporate a backend server. The backend server allows the administrators to edit users, stadiums, teams, players, at bat options (e.g., in baseball-related competitions), game options, and all other aspects of the game. This is a Ruby on Rails (Java) driven system running on an Apache webserver. The persistence is handled by the Database, but can be scaled to use any other database system if required. The backend can be written using Codelgniter to allow an MVC (Model-View-Architecture) approach. This allows code separation from the display. This approach can further utilize JSON and associative arrays to handle the communication as this allows a semi-transparent approach to platform independence. The backend also uses jQuery for the ajax related menu items and HTML/CSS for the graphics and layout displays.

The backend can also trigger any necessary communication between the network 106 and the users 102 during the course of any competition established through the use of the network system 100. For example, when an at bat event is triggered, the network 106 looks up all registered input devices 108 that have come online. These input devices 108 are then notified using APNS with the proper parameters. After the at bat event, if the competition is a point-based competition, as discussed in greater detail herein below, the network 106 calculates which users 102 received points for any given prediction related to that at bat. Additionally, the network 106 can update the point totals of each of the users 102 accordingly, thereby allowing the users 102 to view their point scores relative to the other users 102 that may be participating in the same competition.

FIG. 2 is a simplified schematic illustration of a startup menu 214 usable with the network system and method 100 of FIG. 1A. In particular, as illustrated, the startup menu 214 supplies the user 102 (illustrated in FIG. 1A) with the option to register 216, login 218, adjust the settings 220 of the input device 108 (illustrated in FIG. 1A), and/or create, register and/or amend a personal profile under “My Profile” 222. Once the user 102 has initially registered with the application 110 (illustrated in FIG. 1A), the user 102 is able to login 218 and also customize settings 220 and/or amend the profile 222 during any subsequent use of the application 110.

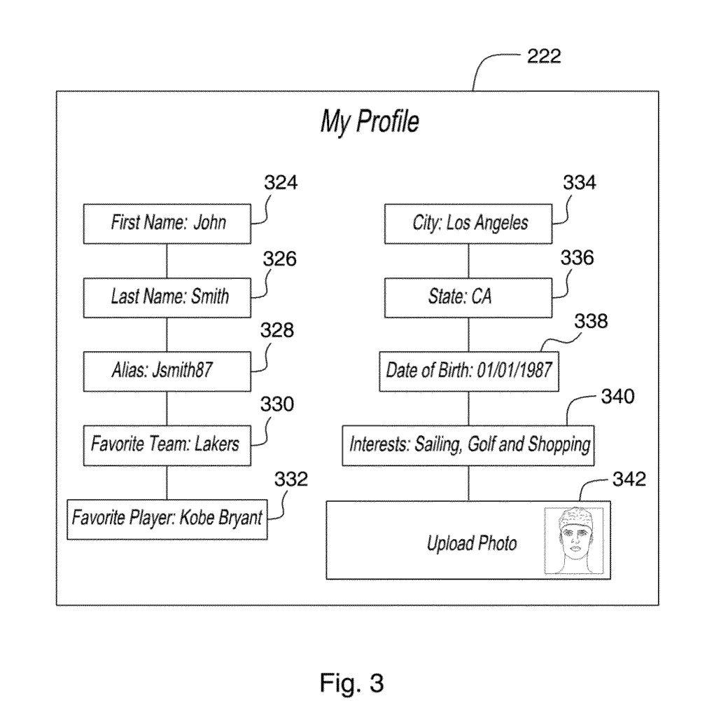

FIG. 3 is a simplified schematic illustration depicting a display for the user 102 (illustrated in FIG. 1A) to establish and/or amend user-supplied profile information under “My Profile” 222. In particular, in certain embodiments, the profile 222 can include certain required information and/or certain optional information so that each user 102 may register (and subsequently login) for online participation with the application 110 (illustrated in FIG. 1A) and the network system 100 (illustrated in FIG. 1A) of the present invention. For example, in some such embodiments, the user 102 has the ability to create a profile 222 including certain personal information relating to the user 102, and such personal information can include, but is not limited to: the user's first name 324, last name 326, an alias 328, favorite team 330 and player 332, city 334 and state 336, a profile photo 338, date of birth 340, and various interests and hobbies 342. Additionally and/or alternatively, the user 102 can also provide such personal information as home town, college attended, fraternity house, and the like.

Additionally, after the user 102 logs in during any subsequent uses of the application 110 and/or the network system 100, the user 102 can change their profile 222 information as desired. The profile information, as provided by the user 102, can then be synced to the network server 106 (illustrated in FIG. 1A) and stored using Apple's CoreData library stack.

In some alternative embodiments, some or all of the personal information that is provided by each of the users 102 for the profile 222 can be shared with or hidden from one or more of the other users 102 who are involved in the same competition. In some such embodiments, such sharing or hiding of the personal information can be controlled by the individual users 102. By allowing the users 102 to share their personal information, the network system 100 and application 110 allow the users 102 to bond with other users 102 on a more personal level. Further, in certain embodiments, the users 102 can connect and chat with other users 102, e.g., based on their profile information, thereby making it a more personal experience allowing users 102 to bond with other users 102 having similar background and interests. For example, if a baseball game is being played between the ‘Angels’ and ‘Tigers’ at Angels Stadium, and one user's profile has information that he graduated from the University of Michigan and is a supporter of Tigers', other users 102 who also attended the same school and/or who are supporting the same team can connect and chat with that user 102, thus allowing bonding of the various users 102 of the game application 110 on a more personal level.

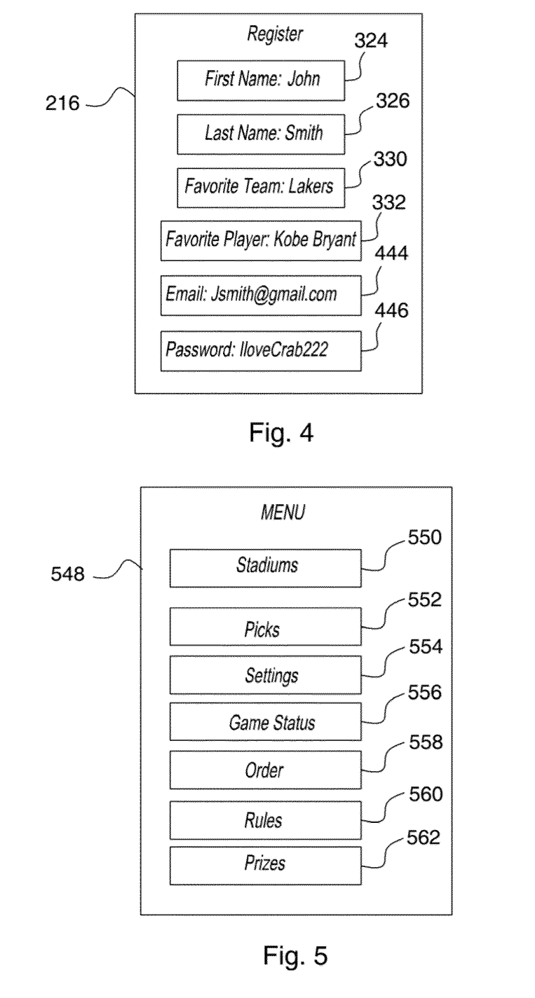

FIG. 4 is a simplified schematic illustration depicting a display for the user 102 (illustrated in FIG. 1A) to access a “Register” interface 216, in which the user 102 can register their information with the network system 100 (illustrated in FIG. 1A) and/or the application 110 (illustrated in FIG. 1A). During the “Register” 216 process, the user 102 has the ability to access and/or review the information provided in the profile 222 option such as First Name 324, Last Name 326, favorite team 330 and player 332 and any additional information that may be included within the profile 222. In one embodiment, the user 102 can further register an email address 444 and create a password 446, unique to the user 102 within the network system 100 of the present disclosure, in order to keep the profile 222 and any other information of the user 102 private and/or protected if desired. All such information provided by the user 102 can then be registered with the network system 100 and/or the application 110 so that the profile 222 can be accessible only by its respective user 102, and/or so that the profile 222 can be shared by the user 102 as specifically directed by the user 102.

FIG. 5 is a simplified schematic illustration depicting a display of a main menu 548 that may be included with the network system 100 of FIG. 1A. In particular, as illustrated in FIG. 5, by accessing the main menu 548, the user 102 (illustrated in FIG. 1A) can access various categories of information. It should be noted that the categories of information specifically illustrated in FIG. 5 are merely provided as examples of some categories of information that may be available to the user 102 through the main menu 548. In different embodiments of the present invention, the main menu 548 can provide the user 102 with access to more or fewer categories of information, and the specific categories of information can include various categories of information not specifically shown in FIG. 5. In one non-exclusive embodiment, as illustrated in FIG. 5, the main menu 548 can allow the user 102 to (i) view stadiums 550 at which sporting events are currently taking place and/or are soon to be taking place; (ii) make any pre-event or in-event predictions or “picks” 552 as desired by the user 102 for purposes of playing the game provided within the application 110 (illustrated in FIG. 1A); (iii) customize the settings 554 of the application 110 and/or the network system 100 as specifically desired by the user 102; (iv) check on the game status 556 of any chosen sporting event and/or of any competition or game created through the application 110 based on any such sporting event; (v) order concessions 558, such as food, drinks and/or other items (e.g., if the user 102 is an actual attendee at, the sporting event); (vi) read the rules 560 of the game provided within the application 110; and/or (vii) see the prizes or awards 562 that may be available based on the performance of the user 102 during the playing of the game.

In certain embodiments, the main menu 548 can be comprised of two basic parts, a standard navigation menu and a tabbed quick navigation menu. When utilizing the standard navigation menu, tapping of the buttons within the standard navigation menu can open up a new screen for the chosen category. Conversely, the tabbed quick navigation menu can provide tabs that simply slide open to the appropriate sub-module when activated. In certain embodiments, the tabbed quick navigation menu can enable the user 102 to more quickly reach parts of the application 110 which are commonly used, including but not limited to the user's pre-event and in-event picks 552 and a page to order concessions 558. Alternatively, the main menu 548 can include only one of a navigation menu and a tabbed quick navigation menu.

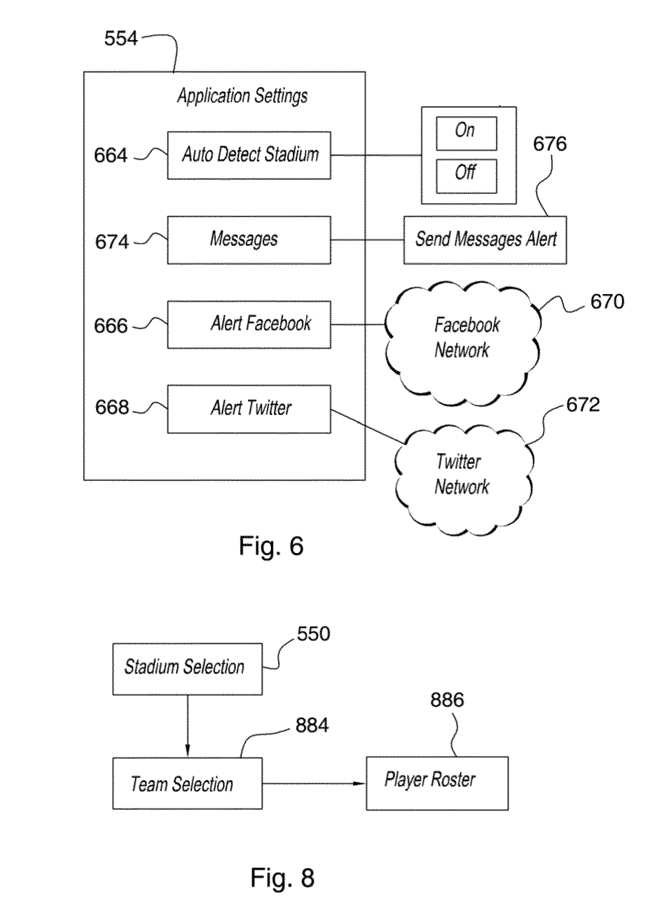

FIG. 6 is a simplified schematic illustration depicting a display for the user 102 (illustrated in FIG. 1A) to access and customize an “Application Settings” interface 554, which may be accessible via the main menu 548 illustrated in FIG. 5. In particular, once the user 102 has created and registered their profile 222 as provided above, FIG. 6 illustrates one nonexclusive embodiment of how the user 102 can customize the application settings 554 to suit the specific desires of the user 102. For example, if the user 102 is an actual attendee at a sporting event, the user 102 can be given the ability to automatically detect the stadium 664 at which the user 102 is present by selectively turning such setting on or off. Additionally, the application settings 554 can also enable the user 102 to provide and/or receive automatic Facebook® 666 and/or Twitter® 668 alerts by connecting to their respective networks 670, 672. For example, the users 102 may update their Facebook® and/or Twitter® account(s) to notify others that they are using the application 110 (illustrated in FIG. 1A) for a particular sporting event, their participation with the network system (illustrated in FIG. 1A), and their overall performance in using the application 110 for the particular sporting event. Further, the application settings 554 can also provide the user 102 with a messages 674 option, including a message alert 676 feature, which gives the user 102 the ability to send or receive messages for various notifications as well to communicate with other users 102 at the sporting event, in real time or with only a reasonable delay. The present disclosure also provides the users 102 with the opportunity to communicate and interact with each other, through a social media site like Facebook® or independent of any such site or service.

In one embodiment, a competition that is established through the application 110 can be restricted, such that only those users 102 that are actual attendees at the sporting event can participate in the competition. By restricting participation in the game to only those users 102 in attendance at the sporting event, the application 110 can create a unique social community during the course of the game for such users 102 to compete amongst one another for various benefits and prizes. In such embodiment, the user 102 must first be detected and/or located within the network system 100 (illustrated in FIG. 1A) as an actual attendee at the sporting event, and then the network system 100 can identify the user's 102 internet-connected input device 108 and allow such user 102 to utilize the application 110 as described herein.

Additionally and/or alternatively, in other embodiments, competitions may be established through the application 110 that can be accessed by any potential users 102, who may be actual attendees or virtual attendees. Still alternatively, the application 110 can allow individual users 102 to allow for only particular users 102 to participate in a particular competition within the application 110, e.g., the users 102 can set up a competition within the application 110 that is only accessible to certain friends, family, etc.

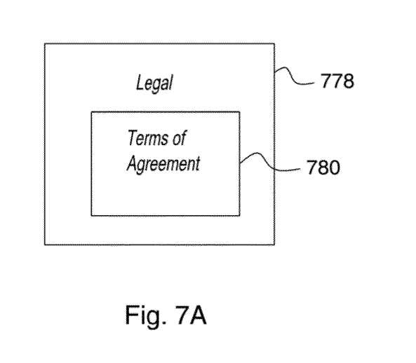

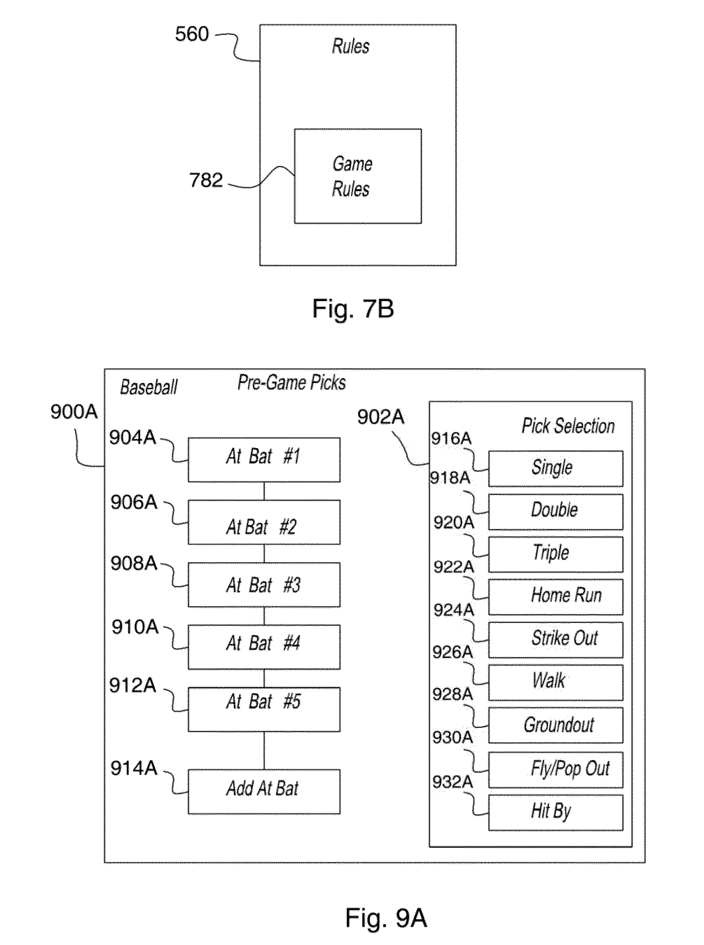

FIG. 7A is a simplified schematic illustration depicting a display for a “Legal” interface 778 that may be included as part of the present invention. In particular, FIG. 7A illustrates that the “Legal” interface 778 provides the user 102 (illustrated in FIG. 1A) with access to a visual display of the relevant legal terms of agreement 780 for use of the network system 100 (illustrated in FIG. 1A) and the application 110 (illustrated in FIG. 1A).

FIG. 7B is a simplified schematic illustration depicting a display for a “Rules” interface 560 that may be included as part of the present invention. More specifically, FIG. 7B illustrates a “Rules” interface 560 page that may be selected from the main menu 548 illustrated in FIG. 5. In this embodiment, the network system 100 (illustrated in FIG. 1A) and the application 110 (illustrated in FIG. 1A) of the present disclosure provide the Rules interface 560 that explains the rules of the game 782 for the users 102 (illustrated in FIG. 1A) to follow in order to correctly participate in the individual contests or games enabled through use of the application 110.

FIG. 8 is a simplified schematic illustration depicting the selection of the stadium, ballpark, arena or other location 550 at which a sporting event is or will occur with which the present invention can be used. For example, in one embodiment, the desired stadium 550 may be selected from the main menu 548 illustrated in FIG. 5. As shown in the embodiment illustrated in FIG. 8, once the desired stadium 550 is selected, the teams 884 participating in the sporting event will appear on the interactive interface for the benefit of the user 102 (illustrated in FIG. 1A). Further, for each of the teams 884 participating in the selected sporting event, an up-to-date player roster 886 can also be provided. In one embodiment, the player roster 886 information may further include the probable and/or stated starting lineup. Additionally and/or alternatively, for individual-based sporting events, e.g., golf, tennis, boxing, etc., the individuals participating in the particular sporting event can be provided to the user 102 via the interactive interface.

As provided in detail herein, upon receiving the player rosters 886 for each of the teams 884 participating in the selected sporting event at the selected sporting venue (and/or upon receiving the list of individuals participating in the selected sporting event), each of the users 102 is given the opportunity to make various predictions, selections or “picks” as to what the users 102 predict will happen during the course of the sporting event. For example, the users 102 may predict or “pick” the outcome of certain individual occurrences during the course of a sporting event, e.g., a pitch or at bat in a baseball game; a play in a football game; a tee shot or putt in a golf tournament; etc. Additionally, the picks of the users 102 may relate to any and all statistical occurrences that may occur during the course of a sporting event, e.g., runs, hits, or errors in a baseball games; yards or touchdowns in a football game; goals, assists or penalties in a hockey game; points, rebounds or assists in a basketball game; etc., that may be accumulated by individual players and/or teams during the entire course of the sporting event. Further, the users 102 may also predict the final outcome of the sporting event or the outcome of any portion of the sporting event, i.e. outcome occurrences. As utilized herein, any individual picks of the users 102 may also be referred to as “predicted outcomes”.

Additionally, in certain embodiments, the picks of the users 102 can be further divided into picks that are made before the sporting event starts, i.e. pre-game picks, and picks that are made after the sporting event has started, i.e. in-game picks. Any and all of such pre-game picks and in-game picks may be based on various predictions that the users 102 may make about the outcome of the sporting event and/or any portion or portions of the sporting event.

It should be noted that the picks made by the users 102, i.e. both pre-game picks and in-game picks, can be initiated by the users 102 themselves or can be initiated via the network 106 (illustrated in FIG. 1A) and/or the application 110 (illustrated in FIG. 1A) sending a query to or otherwise prompting the users 102 to make picks. As such, any and all picks made by the users 102 can be based on communications between the users 102 and the network 106 and/or between the users 102 and the application 110.

Additionally, in one embodiment, the network 106 and/or the application 110 can generate a set of questions about predicting the outcomes of the various categories at specific intervals of time during break periods in the game or otherwise (for example, during innings in a baseball game, quarters in a football game, periods in a basketball game or each separate race at Churchill Downs on the day of the Kentucky Derby) that the users may answer. The questions generated in the application 110 can be based on the series of events occurring during the particular sporting event. Having all the users 102 answer the same questions at a specific point of time during the game can help to provide uniformity within any given competition and can aid in determining the best user 102 by awarding points (or other appropriate awards) to the user 102 who most accurately responds to the questions posed. Moreover, by providing such periodic questions, the network 106 and/or application 110 can increase the user's participation in the game and help the users 102 be more engrossed with the application 110 on their input device 108 (illustrated in FIG. 1A) while enjoying the game.

Further, in one embodiment, the application 110 can be preloaded with one or more picks as to the outcome of certain occurrences during the course of a sporting event or game. In such embodiment, the user 102 can access the preloaded picks and simply make modifications with regard to the picks that he or she would like to change from their preloaded status, instead of having to input his or her picks for each occurrence during the course of a sporting event or game. Among other things, this can provide the user 102 with the benefit of an easier and more enjoyable gaming experience. Moreover, the preloaded picks that may be present within the game application 110 can be based on an algorithm. For example, in one embodiment, one or more players' stats can be analyzed and a regression analysis can be carried out to understand and predict the best possible outcome of certain occurrences during the course of the sporting event. Additionally, such analysis may form the baseline for participation by the users 102, thereby allowing the users 102, among other advantages, a more passive gameplay experience. Further, in one embodiment, the application 110 interface can prompt the user 102 to modify the picks for the game or the sporting event that is occurring in real time.

In various embodiments, the game application 110 can record the various picks selected by all the users 102 of the game application 110 for every player. Additionally, in one embodiment, all the users 102 of the game application 110 can view the picks selected by the other users 102 of the game application 110, thereby enabling the users 102 to make their individual picks based on the picks made by other users 102 of the game application 110. Further, in one embodiment, the picks selected by the user 102, currently or in the past, are viewable by the other users 102 of the game application 110.

Additionally, in one embodiment, the game application 110 interface can comprise an integrated live TV feed. With this design, among other benefits, the integrated live TV feed allows the one or more users 102 to make predictions about the one or more outcomes of the game and at the same time be informed about the series of events occurring in the live game.

Further, in certain embodiments, the application 110 allows the users 102 to watch highlights or replays from the present sporting event, other on-going sporting events throughout the world, or past sporting events. The application 110 can also provide real-time statistics for the present sporting event or other on-going sporting events.

Additionally, in one embodiment, the user 102 can capture an image, e.g., of himself or herself, or video using the input device 108 being using to play the game. Subsequently, the user's image or video can be displayed on one or more screens at the game or the sporting event.

As provided herein, in certain embodiments, the competition between the users 102 is a point-based system that awards points to the user 102 based upon the number of accurate predictions the user 102 makes, both before and/or after the sporting event has commenced, regarding the game and the players. Stated in another manner, the present system and method allows for users 102 to make various pre-game picks and/or in-game picks, such as discussed above, with points being awarded to the users 102 according to the accuracy of their picks. More specifically, any and all “predicted outcomes” are evaluated at an appropriate time, i.e. once the future occurrence has occurred, by the network system 100 (illustrated in FIG. 1A). For example, this can occur after the pitch, the at bat, the play, the period, the inning, the game, the race, etc. has ended, by comparing the “predicted outcomes” to the “actual outcomes” of the specified portion of the sporting event. Subsequently, in such point-based systems, points can be awarded to the users 102 to the extent that the predicted outcomes substantially or exactly match the actual outcomes. Moreover, such quick feedback being provided to the users 102 via the network 106 and application 110 enables the competitions available through the application 110 to be conducted in real-time.

in some embodiments, the application 110 can include and/or provide access to one or more picks pages, which provide the user interface for collection and/or storage of the information of the given user's picks made against the current sporting event in question. In particular, each user 102 can make whatever picks by predicting various outcomes. When this information is saved, it is pushed to the network server 106. In turn, as noted, the network server 106 can then evaluate the accuracy of the picks at an appropriate time, e.g., providing real-time feedback, and then award an appropriate number of points to the users 102 based on the accuracy of their individual picks.

The picks pages can further display such things as the total points each user 102 has accumulated and how many in-event and pre-event picks each user 102 has made, as non-exclusive examples. The picks pages can be synched with the central network server 106 upon each load or prediction to increase the likelihood or ensure that the data is current and/or up to date. Additionally, the network system 100 and/or the application 110 can track each total for the items during the drilldown.

The network server 106 stores the pick information for each and every user 102 in a given competition, and the network server 106 will know which users 102 to notify with points upon each pitch, each at bat and/or each other predicted event. All picks pages can also send over the current pick queue to ensure data integrity and High Availability. This can be further optimized to send over delta data to reduce the network overhead. Additionally, the network server 106 can and will, from time to time, respond with events that will trigger updates on the individual screens of the users 102. As provided herein, the system and method of the present invention will bring the sporting event to life and allow the users 102 to interact with it.

It should be noted that in certain embodiments of the present invention, the number of picks that may be made by any of the users 102 may be limited in order that the winner is not necessarily just likely the individual user 102 who made the most picks. Moreover, in such embodiments, the users 102 may be further limited to a certain number of pre-game picks and a certain number of in-game picks. With this design, the users 102 are not necessarily encouraged to simply make one or more picks with regard to each and every occurrence during the course of the sporting event, e.g., every pitch and at bat that occurs during a game, but perhaps only when the user 102 has a fairly strong idea of what may happen at any point during the sporting event. For example, in such embodiments, the users 102 are not necessarily encouraged to simply make one or more picks with regard to each and every pitch and at bat that occurs during a baseball game, but perhaps only when the user 102 has a fairly strong idea of what may happen on any given pitch or at bat. Alternatively, the number of picks available to any particular user 102 can be performance based, so that the user 102 is rewarded for the accuracy of his or her picks by the ability to make additional picks. Contrarily, the user 102 may have a decreased number of picks as a result of the user 102 making incorrect picks.

Additionally, it should be noted that in certain embodiments, pre-game picks (due to at least perceived increased difficulty) may be worth more points than in-game picks. Still additionally and/or alternatively, in some embodiments, certain pre-game and/or in-game picks may be worth more points than others due to the nature of the picks themselves. For example, in such embodiments, correctly making pre-game and/or in-game picks that are less likely to occur, e.g., no-hitters, triple plays, etc. can be worth more points than more common outcomes, e.g., ground outs, singles, strikes, etc. For example, in one such embodiment, points and benefits are determined based on actuarial data that determines the statistical probability of one of the user's selections occurring. Moreover, in such embodiment, the user 102 is provided points or other benefits when correctly predicting one or more aspect of the sports related events and the amount of points or value of other benefits received is directly correlated to the actuarial data regarding the probability that the sports related event predicted by the user 102 will occur.

As points are awarded, all of the participating users 102 will then be ranked accordingly. In some embodiments, the users 102 may search for an alias or other identifying information for other potential users 102, such as a friend or family member, who may also be interested or are using the application 110 for the present sporting event. Such searches may be accomplished by using a search engine that the system and method offers or by sending invitations using the user's Facebook® (or Twitter®) account(s). This allows the user 102 to compete on both a global scale as well as personally among friends and family.

In some embodiments, during use of the application 110, there can be two major event types that may occur, i.e. game-related events and ad-related events. Within the application 110, the event pages themselves communicate with each other using the Apple® Internal Messaging (iMessage) or equivalent system and respond to events triggered by APNS (Apple Push Notification Services) or equivalent system. Whenever an event occurs, the application relays the request to the proper class, with each event triggering a different reaction inside the application 110.

Game-related events include the beginning of a game, the end of a game, and anything having to do with the players. For instance, the start of a game will switch the pre-event mode over to the in-event mode, sending all future picks the user 102 will make to the in-game mode. A different event can trigger a point update request for users 102 to get the results from the network server 106 and update their displays, e.g., in real-time. For example, any at bat events can request the full pick results for the given user 102 to comply with High Availability, but can be reduced later to only send packets that are affected.

In ad-related events, the network system 100 allows the users 102 to receive ad display requests over APNS. This will trigger a screen to display an ad on all participating input devices 108. For example, the network system 100 can allows HTML content to be added and displayed as advertisements on all participating devices. This can range from dynamic content, to videos all the way to animations. The user 102 will be able to select any of the advertisements where the user 102 expresses interest in receiving more information. By clicking on the advertisement, the user's input device 108 can be directed to an internet web site using the device's internet web browser 112 (illustrated in FIG. 1A). The web browser may be any type, including, but not limited to, Chrome®, Safari®, Microsoft Internet Explorer®, Mozilla Firefox®, Netscape Navigator®, or any suitable browser capable of connecting to the Internet.

Additionally, the screen can further include a timer, which shows the remaining display time which is counted down until it reaches zero. Once the timer counts down to zero, the page can be automatically hidden, which allows a centralized display of ads over multiple input devices 108. In one embodiment, quitting the application 110 or waiting for the timer to go down is the only way to close this page.

Additionally, in one embodiment, the advertisements that are displayed on any particular input device 108 can be based upon the expressed interests of the user 102, e.g., as provided in the user's profile 222. Alternatively, the advertisements can be based on the brands that one or more players of the game endorse. By thus connecting the player with the brand, a greater impact may be created on the user 102.

Further, in one embodiment, the users 102 can receive increased benefits, e.g., gift vouchers, gift coupons, discounts, etc. related to the advertisements based on making purchases before, during or after the sporting event and watching and sharing the advertisements.

In yet another embodiment, the present invention can further include numerous children's games that are simplified or unrelated to the statistical performances of players or the outcome of the game. Examples include, but are not limited to, picking the winner of a simulated race, guessing games referring to icons or markers throughout a stadium, or guessing where foul balls will land in a baseball game. The children's games can either be incorporated into the regular version of the game, or separated into its own downloadable application.

As detailed herein below, certain exemplary features and embodiments of the present invention will be described primarily in relation to use of the application 110, the network 106 and the network system 100 in relation to a baseball game. In particular, in such embodiments, it should be noted that the various pre-game and in-game picks, i.e. the predicted outcomes, can relate to the individual players (i.e. various batting, pitching and/or fielding (defensive) statistics), or to the teams (i.e. various batting, pitching and/or fielding (defensive) statistics) participating in the selected sporting event. For example, a non-exclusive list of the statistics that the picks for individual batters may relate to include, but are not limited to: at bats, runs, hits, singles, doubles, triples, home runs, runs batted in, stolen bases, walks, strike outs, sacrifices, sacrifice flies, and hit by pitches. Further, a non-exclusive list of the statistics that the picks for the individual pitchers may relate to include, but are not limited to: innings pitched, batters faced, hits, runs, earned runs, walks, strikeouts, wins, losses, saves, hit by pitches, wild pitches and balks. Still further, a non-exclusive list of the defensive or fielding statistics for individual players may relate to include, but are not limited to: fielding chances, put outs, assists, errors, double plays, caught stealing and passed balls. Moreover, it should be noted that any such picks, i.e. either pre-game or in-game picks, may be related to the entirety of the sporting event or only certain portions (e.g., certain specified innings or at bats) of the sporting event.

Additionally, a similar listing of possible statistical picks can be provided for each of the teams that are participating in the selected sporting event, with any such picks again being potentially related to the entirety of the sporting event or only certain portions of the sporting event.

Further, additional picks may be made regarding the overall outcome of the sporting event, e.g., which team wins, the final score, total runs scored, total home runs, total hits, total errors, runners left on base, and the like.

Additionally, in some embodiments, predictions or picks can be made regarding the outcome of individual pitches that are made during the course of the sporting event. For example, as provided in greater detail herein below, the users 102 can make predictions for individual pitches regarding an area in which the pitch will end up (i.e. the location of the pitch), the type of pitch being thrown (e.g., fastball, curve ball, slider, change up, etc.), the speed of the pitch, and/or whether the pitch will be a ball, a called strike, a swinging strike, a batted ball, a foul ball, etc. For example, the user can draw a circle on the screen or tap the screen (e.g., for the smallest circle possible) to predict the location of the pitch and then the user is prompted to predict whether it will be a ball or strike, and then what type of pitch it is (fastball, breaking ball, change up, etc.). The users 102 can then receive points for correct predictions and the smaller the circle (i.e. the smaller the area predicted for the location of the pitch) the more points that are awarded. Following the individual pitches and/or the at bat, the users 102 can then be provided with a summary of their points and picks for the at bat.

Still further, in certain embodiments, picks can also be made by the users 102 with regard to potential managerial and/or strategic decisions that may occur throughout the course of the sporting event. Additionally, such managerial and/or strategic decisions can be related to offense or defense (including pitching). For example, the user 102 may make picks when they believe that the manager is likely to call for a bunt, an attempted stolen base, a hit-and-run, a pitch out, a pickoff attempt, an intentional walk, a pinch hitter, a pinch runner, a pitching change (including what pitcher may be called in from the bullpen and/or whether the new pitcher is likely to be left-handed or right-handed), etc. In certain embodiments, the users 102 may be prompted with a view of the fielders/batter/base runners/etc. prior to making such predicted outcomes. Additionally, in some such embodiments, the users 102 may have a certain specified number of such managerial and/or strategic picks, e.g., ten, to make throughout the course of the game. Further, in one embodiment, every time the users 102 make such picks, the picks can be valid from the time of the pick until the end of that inning.

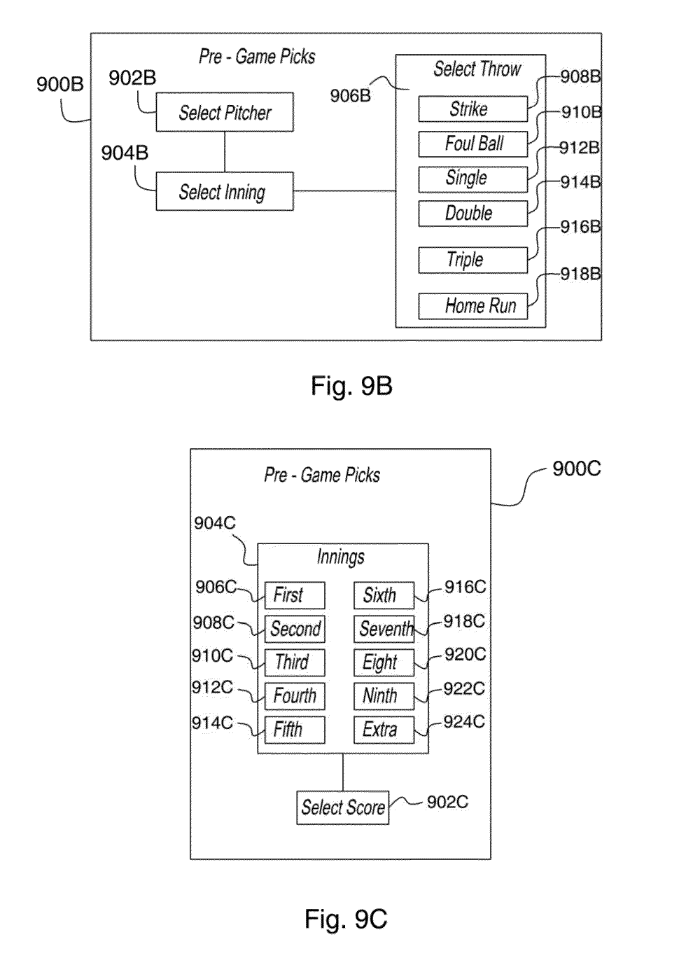

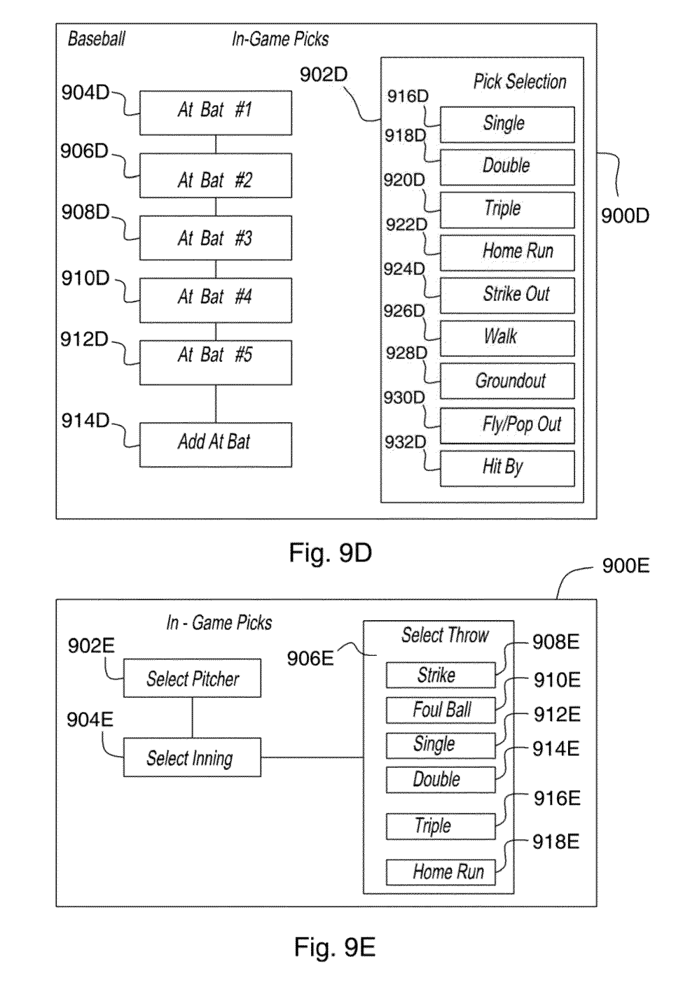

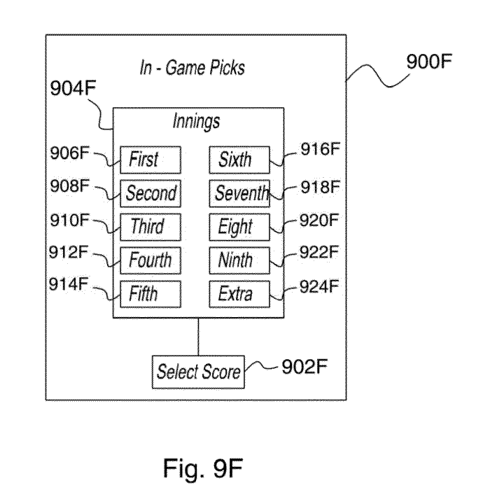

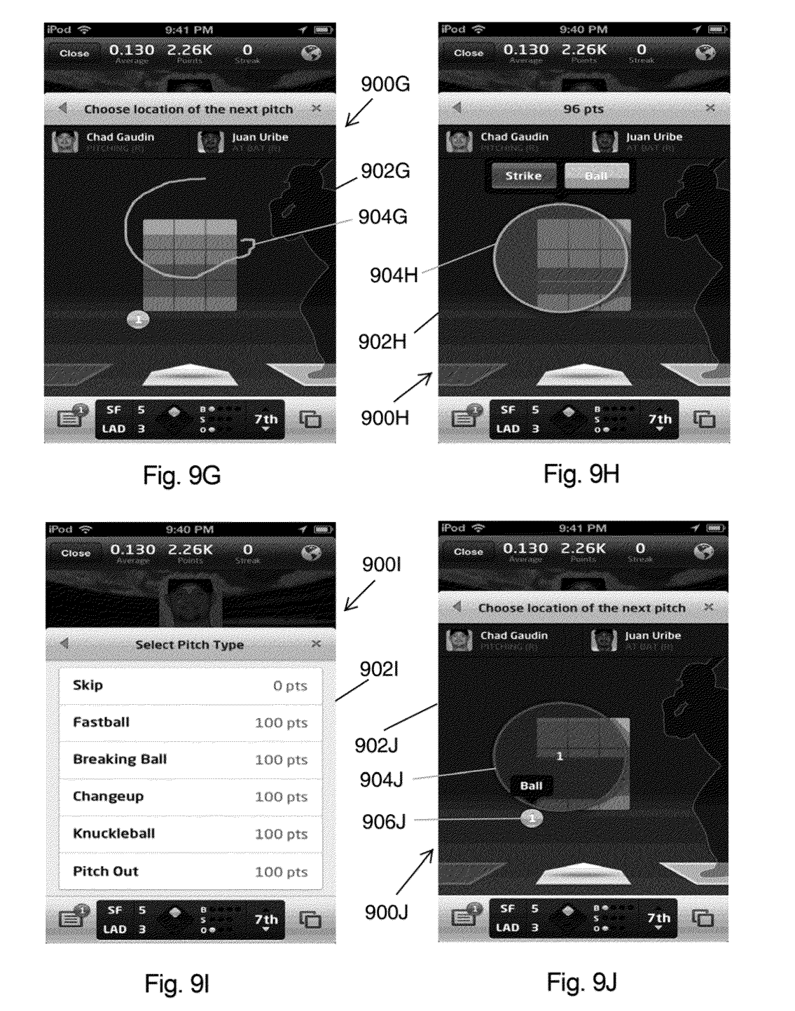

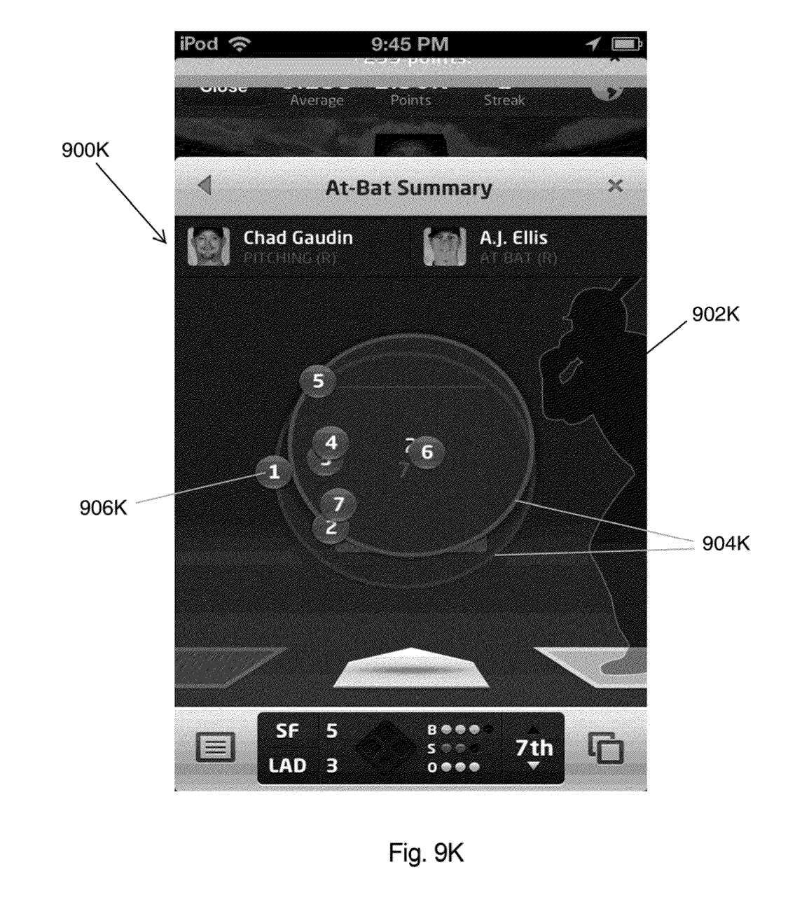

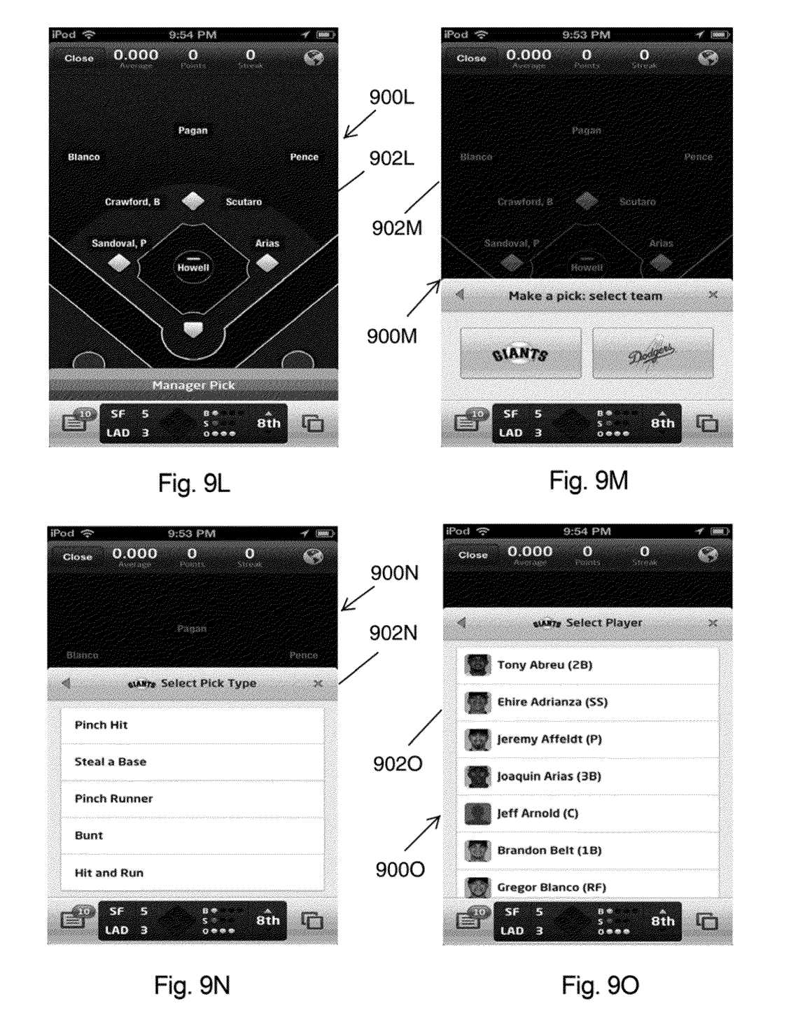

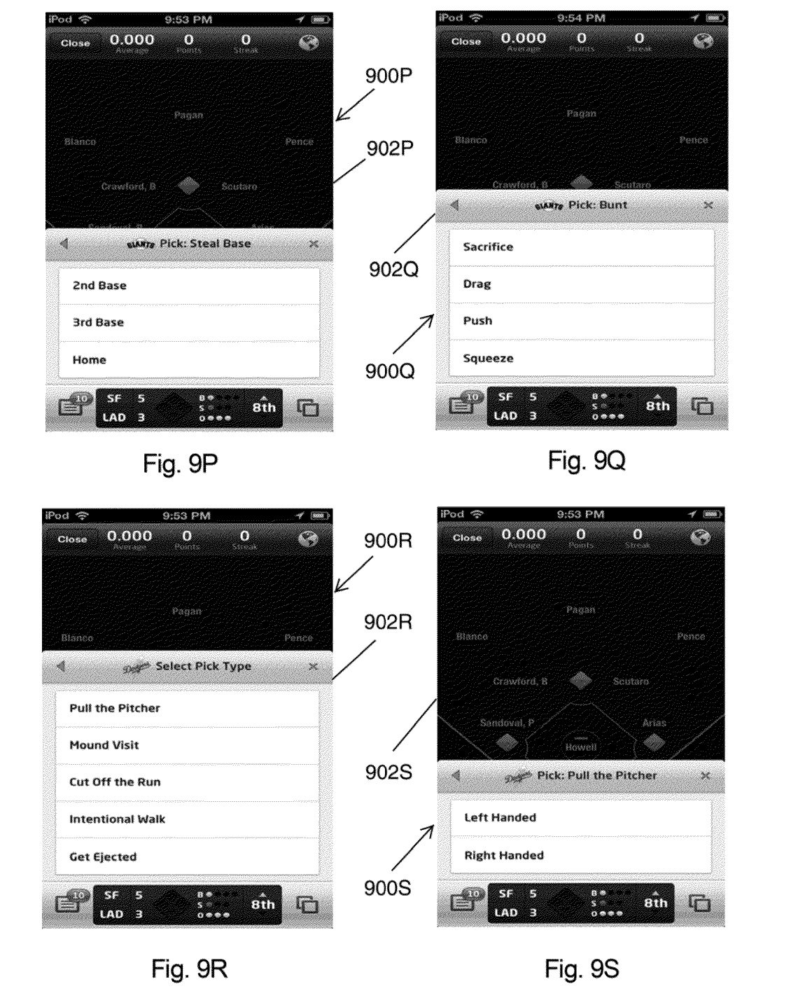

FIGS. 9A-9S relate to pages and/or interfaces that may be available to the users 102 to communicate various predicted outcomes to the network 106 and application 110 in relation to individual occurrences or events before and/or during the course of a baseball game. For example, FIG. 9A is a simplified schematic illustration of an embodiment of a pre-game picks page 900A depicting certain pre-game picks that users 102 (illustrated in FIG. 1A) may select in relation a baseball game. In particular, as shown in the specific embodiment illustrated in FIG. 9A, the pre-game picks 902A can relate to individual statistics that include whether a selected player, i.e. batter, will have various at bats 904A-914A that results in a single 916A, a double 918A, a triple 920A, a home run 922A, a strikeout 924A, a walk 926A, a groundout 928A, a fly-out/pop-out 930A, or getting hit by a pitch 932A. FIG. 9A illustrates the particular player having at bats #1-5 904A-912A, with the option of additional at bats 914A. Additionally and/or alternatively, the pre-game picks can relate to more or fewer individual batting statistics than those specifically illustrated in FIG. 9A.

FIG. 9B is a simplified schematic illustration of another embodiment of a pre-game picks page 900B depicting certain pre-game picks that users 102 (illustrated in FIG. 1A) may select in relation to a baseball game. In particular, as shown in the specific embodiment illustrated in FIG. 9B, the users 102 can select individual pitchers 9028 per inning 904B and the pre-game picks can relate to individual statistics that include whether any particular pitch or throw 906B, any at bat, or any inning 904B of the selected pitcher 902B will result in and/or include a strike 908B, a foul ball 910B, a single 912B, a double 914B, a triple 916B, or a home run 918B. Additionally and/or alternatively, the pre-game picks can relate to more or fewer individual pitching statistics than those specifically illustrated in FIG. 9B.

FIG. 9C is a simplified schematic illustration of still another embodiment of a pre-game picks page 900C depicting certain pre-game picks that users 102 (illustrated in FIG. 1A) may select in relation to a baseball game. In particular, as shown in the specific embodiment illustrated in FIG. 9C, the users 102 can make pre-game predictions as to the total score 902C either during or at the end of each inning 904C-924C and/or the number of runs scored in any of the innings 904C-924C, as well as the final score of the game. Additionally and/or alternatively, the pre-game picks can relate to more or fewer team outcome-based statistics than those specifically illustrated in FIG. 9C.

FIG. 9D is a simplified schematic illustration of an embodiment of an in-game picks page 900D depicting certain in-game picks that users 102 (illustrated in FIG. 1A) may select in relation to a baseball game. In particular, as shown in the specific embodiment illustrated in FIG. 9D, the in-game picks 902D can relate to individual statistics that include whether a selected player 904D-914D, e.g. the batter, will have an at bat that results in a single 916D, a double 918D, a triple 920D, a home run 922D, a strikeout 924D, a walk 926D, a groundout 928D, a fly-out/pop-out 930D, or getting hit by a pitch 932D. Additionally and/or alternatively, the in-game picks can relate to more or fewer individual batting statistics than those specifically illustrated in FIG. 9D.

FIG. 9E is a simplified schematic illustration of another embodiment of an in-game picks page 900E depicting certain in-game picks that users 102 (illustrated in FIG. 1A) may select in relation to a baseball game. In particular, as shown in the specific embodiment illustrated in FIG. 9E, the users 102 can select individual pitchers 902E per inning 904E and the in-game picks can relate to individual statistics that include whether any particular pitch or throw 906E, any at bat, or any inning 904E of the selected pitcher 902E will result in and/or include a strike 908E, a foul ball 910E, a single 912E, a double 914E, a triple 916E, or a home run 918E. Additionally and/or alternatively, the in-game picks can relate to more or fewer individual pitching statistics than those specifically illustrated in FIG. 9E.

FIG. 9F is a simplified schematic illustration of still another embodiment of an in-game picks page 900F depicting certain in-game picks that users 102 (illustrated in FIG. 1A) may select in relation to a baseball game. In particular, as shown in the specific embodiment illustrated in FIG. 9F, the users 102 can make pre-game predictions as to the total score 902F at the end of each inning 904F-924F and/or the number of runs scored in any innings 904F-924F, as well as the final score of the game. Additionally and/or alternatively, the in-game picks can relate to more or fewer team outcome-based statistics than those specifically illustrated in FIG. 9F.

FIGS. 9G-9K are alternative simplified screen shots illustrating embodiments of a pitch selection interface 900G-900K for a baseball game that can be incorporated within the network system 100 illustrated in FIG. 1A. As shown in FIGS. 9G-9K, the user 102 (illustrated in FIG. 1A) has the ability to predict the location of the next pitch, the type of pitch it will be and the outcome of the pitch, e.g., strike or ball. Additionally, in some embodiments, the user 102 may also be able to predict the speed of the pitch among other possible predictions.

FIG. 9G is a simplified screen shot 902G illustrating that the user 102 can manually predict the location of the next pitch. In particular, FIG. 9G shows how the user 102 can provide a manually drawn circle 904G that illustrates the general area in which the user 102 believes that the next pitch will cross the plate. It should be noted that the size of the circle can be a determining factor in how many points (or other awards) are available for an accurate predicted outcome. More specifically, in one embodiment, the smaller the circle chosen by the user 102 for the location of the next pitch, the greater the number of points that are awarded for an accurate prediction because the smaller circle makes the actual outcome less likely to match the predicted outcome.

FIG. 9H is another simplified screen shot 902H that illustrates a prediction by the user 102 (illustrated in FIG. 1A) with regard to the location of the next pitch, as well as whether the user 102 believes that the next pitch will be a strike or a ball. In this embodiment, the circle 904H is shown as having been automatically drawn in a particular location. In alternative embodiments, the automatically drawn circle 904H can be an interpretation of a manually drawn location circle, e.g., the manually drawn circle 904G illustrated in FIG. 9G, or it can be the result of a manipulation of the screen by the user 102 to select the area and size of the predicted location of the next pitch.

FIG. 9I is a simplified screen shot 902I that illustrates the user 102 (illustrated in FIG. 1A) being allowed to predict the type of pitch for the next pitch. FIG. 9I further provides a simple example of the number of points that may be available based on the prediction of the type of pitch for the next pitch. It is recognized that the number of points can vary from those shown in FIG. 9I, and that the point values shown in FIG. 9I are provided for ease of understanding only.

FIG. 9J is a simplified screen shot 902J that illustrates the location and result of the predicted pitch after the pitch has been made. For example, in this instance, the pitch was a ball that was just outside the circle that was selected by the user 102 for the location of the pitch. As illustrated in FIG. 9J, the large circle 904J with the number “1” in the center represents the predicted outcome, i.e. location, for the first pitch in the at-bat; and the small circle 906J with the number “1” in the middle represents the actual outcome, i.e. location, for the first pitch in the at-bat.

FIG. 9K is a simplified screen shot 902K that provides a full summary of all of the pitches that occurred during a particular at bat. Additionally, such simplified screen shot 902K, or possibly one or more additional simplified screen shots, can further provide a summary of the results of each of the predictions that the user 102 made during the course of the at bat, and any points (or other awards) that the user 102 may have received based on the accuracy of their predictions during the at-bat. As illustrated in FIG. 9K, the two large circles 904K represent the predicted outcomes, i.e. locations, for certain individual pitches that occurred during the course of the at-bat; and the seven small circles 906K represent the actual outcomes, i.e. locations, of each of the pitches that occurred during the course of the at-bat. It should be understood that the numbers shown within each of the large circles 904K and the small circles represent the number, i.e. the chronology with “1” representing the first pitch, “2” representing the second pitch, “3” representing the fourth pitch, etc., of the pitches during the course of the at-bat.

FIGS. 9L-9S are alternative simplified screen shots illustrating embodiments of a managerial selection interface 900L-900S for a baseball game that can be incorporated within the network system and method of FIG. 1A. In particular, FIGS. 9L-9S illustrate certain managerial and/or strategic predictions that the user 102 (illustrated in FIG. 1A) can make during the course of a baseball game, e.g., during the course of a particular at bat or during the course of a particular inning.

Initially, FIG. 9L illustrates a simplified screen shot 902L that provides the user 102 with the current game situation, e.g., inning, score, outs, runners, etc., for the particular sporting event. It should be noted that the current game situation as shown can be updated regularly, e.g., after each pitch, such that current game situation can be provided accurately in real-time.

FIG. 9M illustrates a simplified screen shot 902M that provides the user 102 (illustrated in FIG. 1A) with the opportunity to choose either the offensive team (i.e. the team batting) and/or the defensive team (i.e. the team in the field) about which the user 102 wants to make any potential managerial and/or strategic predictions.

FIG. 9N illustrates a simplified screen shot 902N that lists some of the potential predicted managerial and/or strategic decisions that may be selected by the user 102 (illustrated in FIG. 1A) in relation to the team current at bat in the baseball game. In particular, FIG. 9N illustrates that the user 102 may predict that the team at bat (and/or their manager) may choose to use a pinch hitter, steal a base, use a pinch runner, bunt and/or try a hit-and-run play during the course of the inning (or during the course of a particular at bat). In alternative embodiments, the possible managerial and/or strategic decisions that the user 102 can choose from may be greater than or less than those specifically illustrated in FIG. 9N.

FIG. 9O illustrates a simplified screen shot 902O that allows the user 102 (illustrated in FIG. 1A) to choose the player or players from the team at bat who may be involved in the predicted managerial and/or strategic decision, e.g., which player may be asked to bunt or try to steal a base.

FIG. 9P illustrates a simplified screen shot 902P that allows the user 102 (illustrated in FIG. 1A) to predict which base that a player on the batting team will try to steal, i.e. second base, third base, or home.

FIG. 9Q illustrates a simplified screen shot 902Q that allows the user 102 (illustrated in FIG. 1A) to predict the type of bunt that the player will attempt to accomplish, e.g., a sacrifice bunt, a drag bunt, a push bunt, and/or a squeeze bunt.

FIG. 9R illustrates a simplified screen shot 902R that lists some of the potential predicted managerial and/or strategic decisions that may be selected by the user 102 (illustrated in FIG. 1A) in relation to the team currently in the field in the baseball game. In particular, FIG. 9R illustrates that the user 102 may predict that the team in the field (and/or their manager) may choose to pull the pitcher, visit the mound, try to cut off a run at the plate and/or issue an intentional walk during the course of the inning (or during the course of a particular at bat). Additionally, the user 102 may further be allowed to predict whether the manager and/or one of the players may get ejected during the course of the inning (or during the course of a particular at bat). In alternative embodiments, the possible managerial and/or strategic decisions that the user 102 can choose from may be greater than or less than those specifically illustrated in FIG. 9R.

Further, FIG. 9S illustrates a simplified screen shot 902S that allows the user 102 (illustrated in FIG. 1A) to predict whether a new pitcher chosen to replace the pitcher being pulled will be a left-handed pitcher or a right-handed pitcher. Moreover, in certain embodiments, the user 102 may be given the opportunity to choose the specific pitcher that will be selected to enter the game on behalf of the team in the field.

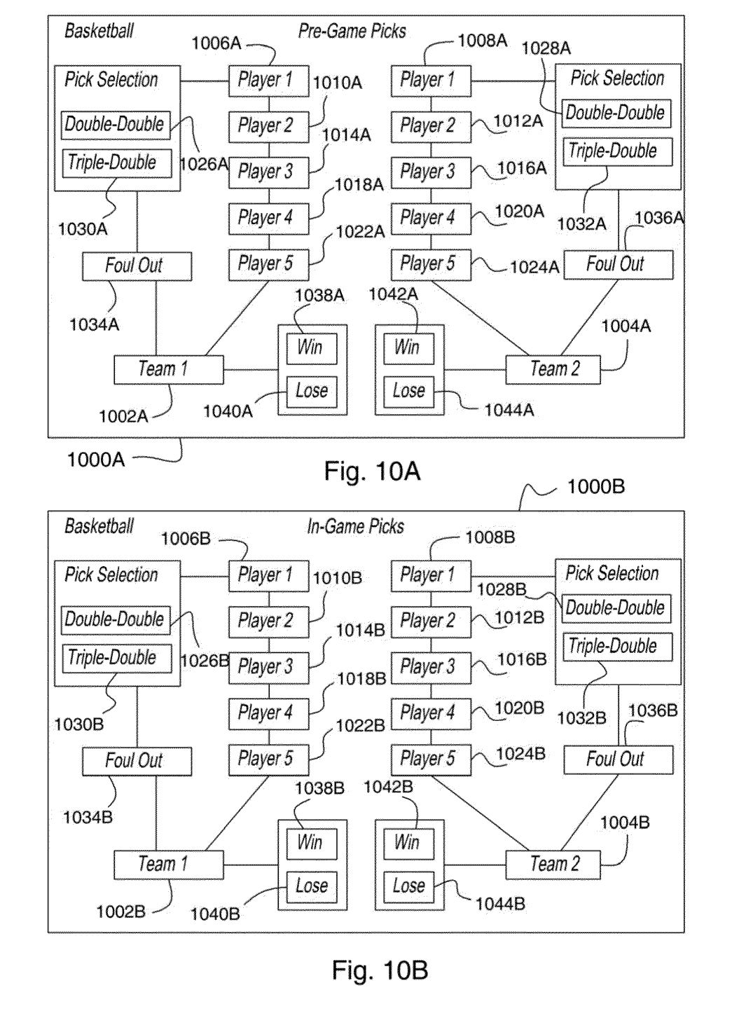

As noted above, the network system 100 (illustrated in FIG. 1A) and application 110 (illustrated in FIG. 1A) are available for use with various other events, including various other sporting events. For example, FIG. 10A is a simplified schematic illustration of another embodiment of a pre-game picks page 1000A depicting certain pre-game picks that users 102 (illustrated in FIG. 1A) may select in relation to a basketball game. In certain non-exclusive alternative embodiments, before a specifically selected basketball game, the users 102 may be allowed to make pre-game picks relating to the number of points, field goals, three-point field goals, free throws, rebounds, assists, steals, blocked shots, turnovers, and/or fouls that any individual players and/or each team will have during the course of the basketball game and/or during any specified portion of the basketball game. Additionally and/or alternatively, the pre-game picks may relate to more or fewer statistics than those specifically listed above. Further, in some embodiments, the users 102 may also be able to make pre-game picks as to what the score will be at the end of the game as well as at the end of each of the quarters of the game.

In the particular embodiment illustrated in FIG. 10A, for each player 1006A-1024A on each of the teams 1002A, 1004A participating in the basketball game, the users 102 are able to make pre-game picks for each team 1002A, 1004A including, but not limited to, whether each player 1006A-1024A will have a “double-double” 1026A, 1028A, “triple-double” 1030A, 1032A or foul out 1034A, 1036A during the course of the game. Further, the users 102 have the ability make picks as to the ultimate winner and/or loser 1038A-1044A of the sporting event and/or predict the score at the end of the game or at the end of each quarter of the game. Additionally and/or alternatively, the pre-game picks can relate to more or fewer statistics or outcomes than those specifically illustrated in FIG. 10A.

FIG. 10B is a simplified schematic illustration of another embodiment of an in-game picks page 1000B depicting certain in-game picks that users 102 (illustrated in FIG. 1A) may select in relation to a basketball game. In certain non-exclusive alternative embodiments, during a specifically selected basketball game, the users 102 may be allowed to make in-game picks relating to the number of points, field goals, three-point field goals, free throws, rebounds, assists, steals, blocked shots, turnovers, and/or fouls that any individual players and/or each team will have during the course of the basketball game and/or during any specified portion of the basketball game. Additionally and/or alternatively, the in-game picks may relate to more or fewer statistics than those specifically listed above. Further, in some embodiments, the users 102 may also be able to make in-game picks as to what the score will be at the end of the game as well as at the end of each of the quarters of the game.

In the particular embodiment illustrated in FIG. 106, for each player 1006B-1024B on each of the teams 1002B, 1004B participating in the basketball game, the users 102 are able to make in-game picks for each team 1002B, 1004B including, but not limited to, whether each player 1006B-1024B will have a “double-double” 1026B, 1028B, “triple-double” 1030B, 1032B or foul out 1034B, 1036B during the course of the game. Further, the users 102 have the ability make picks as to the ultimate winner and/or loser 1038B-1044B of the sporting event and/or predict the score at the end of the game or at the end of each quarter of the game. Additionally and/or alternatively, the in-game picks can relate to more or fewer statistics or outcomes than those specifically illustrated in FIG. 10B.

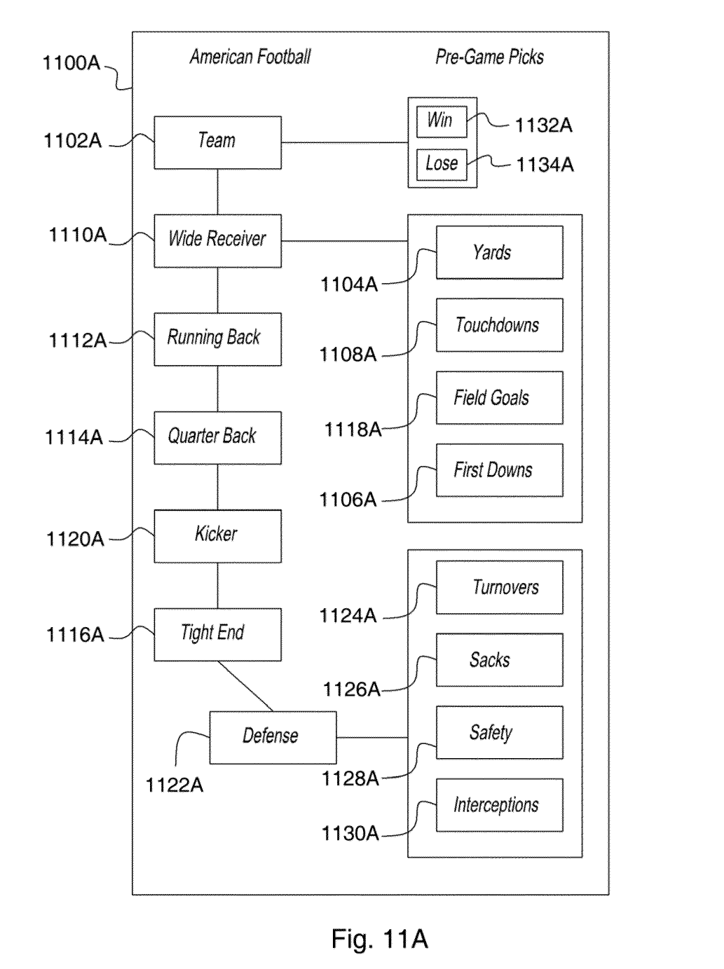

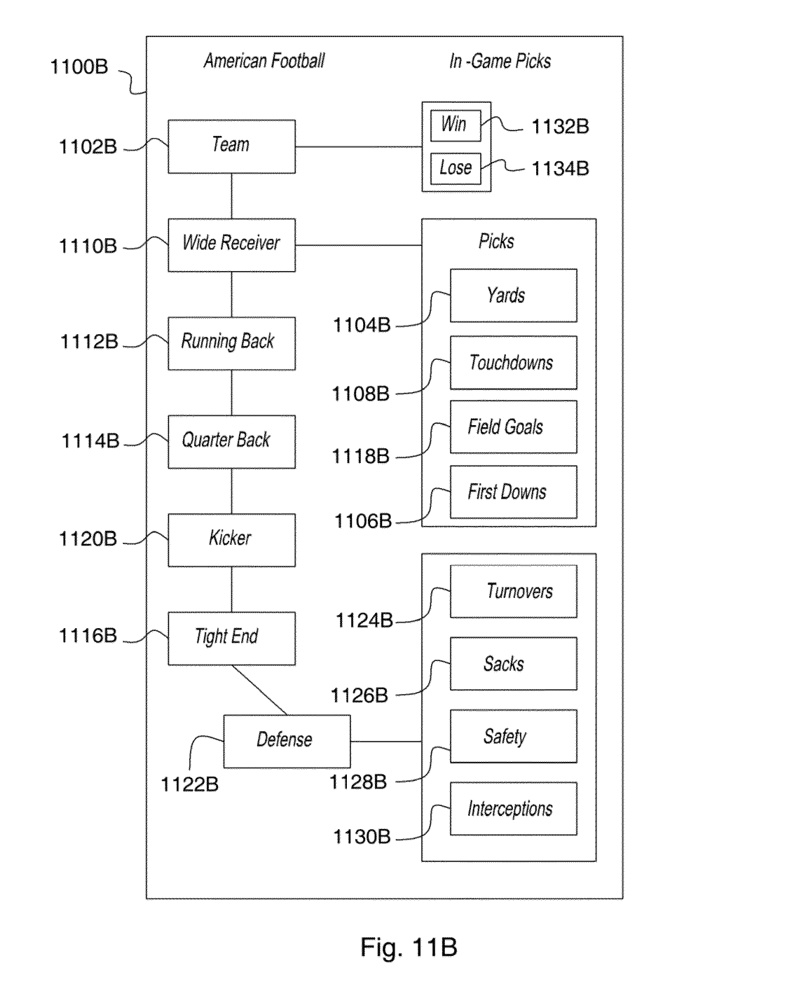

FIG. 11A is a simplified schematic illustration of another embodiment of a pre-game picks page 1100A depicting certain pre-game picks that users 102 (illustrated in FIG. 1A) may select in relation to an American football game. In certain non-exclusive alternative embodiments, before a specifically selected football game, the users 102 may be allowed to make various pre-game picks relating to certain statistics that may be accumulated during the course of the football game and/or during any specified portion of the football game. For example, in such embodiments, the pre-game picks may relate to: for quarterbacks, the number of passes, completions, yards, touchdowns and interceptions; for running backs, the number of carries, yards, yards per carry, touchdowns and fumbles; for receivers (which could be wide receivers, tight ends, running backs, etc.), the number of catches, yards, yards per catch, touchdowns and fumbles; for kickers, the number of field goals, longest field goal, and number of extra points; for punters, the number of punts, the longest punt, the average yards per punt and the net yards per punt; for kick returners and/or punt returners, the number of returns, the number of yards, the yards per return, touchdowns and fumbles; and for defensive players, the number of tackles (solo, assists and total), sacks, fumble recoveries, interceptions and touchdowns. Additionally and/or alternatively, the pre-game picks may relate to more or fewer statistics than those specifically listed above. Further, in some embodiments, the users 102 may also be able to make pre-game picks as to what the score will be at the end of the game as well as at the end of each of the quarters of the game.

In the particular embodiment illustrated in FIG. 11A, for each player on each of the teams 1102A participating in the football game, the users 102 are able to make pre-game picks for almost every aspect of the sporting event. Possible picks for each team 1102A include but are not limited to the approximate amount of yards 1104A, first downs 1106A and touchdowns 1108A for wide receivers 1110A, running backs 1112A, quarterbacks 1114A, and tight ends 1116A; and field goals 1118A by kicker(s) 1120A. For the defense 1122A, users have the ability to make picks for turnovers 1124A, sacks 1126A, safeties 1128A, and interceptions 1130A. Users 102 are also able to decide which team 1102A will win 1132A or lose 1134A or predict the score at the end of the game or at the end of each of the quarters.

FIG. 11B is a simplified schematic illustration of another embodiment of an in-game picks page 1100B depicting certain in-game picks that users 102 (illustrated in FIG. 1A) may select in relation to an American football game. In certain non-exclusive alternative embodiments, during a specifically selected football game, the users 102 may be allowed to make various in-game picks relating to certain statistics that may be accumulated during the course of the football game and/or during any specified portion of the football game. For example, in such embodiments, the in-game picks may relate to: for quarterbacks, the number of passes, completions, yards, touchdowns and interceptions; for running backs, the number of carries, yards, yards per carry, touchdowns and fumbles; for receivers (which could be wide receivers, tight ends, running backs, etc.), the number of catches, yards, yards per catch, touchdowns and fumbles; for kickers, the number of field goals, longest field goal, and number of extra points; for punters, the number of punts, the longest punt, the average yards per punt and the net yards per punt; for kick returners and/or punt returners, the number of returns, the number of yards, the yards per return, touchdowns and fumbles; and for defensive players, the number of tackles (solo, assists and total), sacks, fumble recoveries, interceptions and touchdowns. Additionally and/or alternatively, the in-game picks may relate to more or fewer statistics than those specifically listed above. Further, in some embodiments, the users 102 may also be able to make in-game picks as to what the score will be at the end of the game as well as at the end of each of the quarters of the game.

In the particular embodiment illustrated in FIG. 11B, for each player on each of the teams 1102B participating in the football game, the users 102 are able to make in-game picks for almost every aspect of the sporting event. Possible picks for each team 1102B include but are not limited to the approximate amount of yards 1104B, first downs 1106B and touchdowns 1108E for wide receivers 1110B, running backs 11128, quarterbacks 1114B, and tight ends 1116B; and field goals 1118B by kicker(s) 1120B. For the defense 1122B, users have the ability to make picks for turnovers 1124B, sacks 1126B, safeties 1128B, and interceptions 1130B. Users 102 are also able to decide which team 1102B will win 1132B or lose 1134B or predict the score at the end of the game or at the end of each of the quarters.

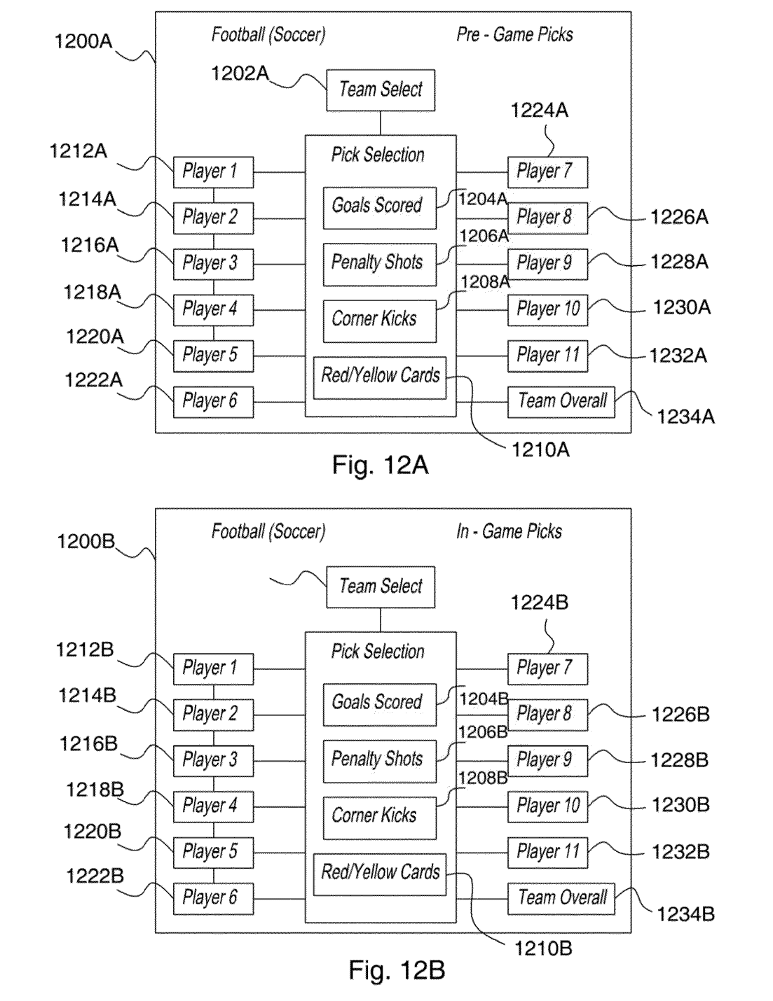

FIG. 12A is a simplified schematic illustration of another embodiment of a pre-game picks page 1200A depicting certain pre-game picks that users 102 (illustrated in FIG. 1A) may select in relation to a football (soccer) match. In certain non-exclusive alternative embodiments, before a specifically selected soccer match, the users 102 may be allowed to make pre-game picks relating to the number of shots, shots on goal, goals, assists, offsides, corner kicks, yellow cards, red cards, time of possession, saves, and fouls that any individual players and/or each team will have during the course of the soccer match and/or during any specified portion of the soccer match. Additionally and/or alternatively, the pre-game picks may relate to more or fewer statistics than those specifically listed above. Further, in some embodiments, the users 102 may also be able to make pre-game picks as to what the score will be at the end of the game as well as at the end of each of the halves of the match.

In the particular embodiment illustrated in FIG. 12A, for each player 1212A-1232A on each of the teams 1202A participating in the soccer match, the users 102 are able to make pre-game picks for each team 1202A regarding almost every aspect of the game including, but not limited to, how many goals will be scored 1204A, penalty shots 1206A, corner kicks 1208A, and red and yellow cards 1210A received for each player 1212A-1232A and the overall team 1234A.

FIG. 12B is a simplified schematic illustration of another embodiment of an game picks page 1200B depicting certain in-game picks that users 102 (illustrated in FIG. 1A) may select in relation to a football (soccer) match. In certain non-exclusive alternative embodiments, during a specifically selected soccer match, the users 102 may be allowed to make in-game picks relating to the number of shots, shots on goal, goals, assists, offsides, corner kicks, yellow cards, red cards, time of possession, saves, and fouls that any individual players and/or each team will have during the course of the soccer match and/or during any specified portion of the soccer match. Additionally and/or alternatively, the in-game picks may relate to more or fewer statistics than those specifically listed above. Further, in some embodiments, the users 102 may also be able to make in-game picks as to what the score will be at the end of the game as well as at the end of each of the halves of the match.

In the particular embodiment illustrated in FIG. 12B, for each player 1212B-1232B on each of the teams 1202B participating in the soccer match, the users 102 are able to make in-game picks for each team 1202B regarding almost every aspect of the game including, but not limited to, how many goals will be scored 1204B, penalty shots 1206B, corner kicks 1208B, and red and yellow cards 1210B received for each player 1212B-1232B and the overall team 1234B.

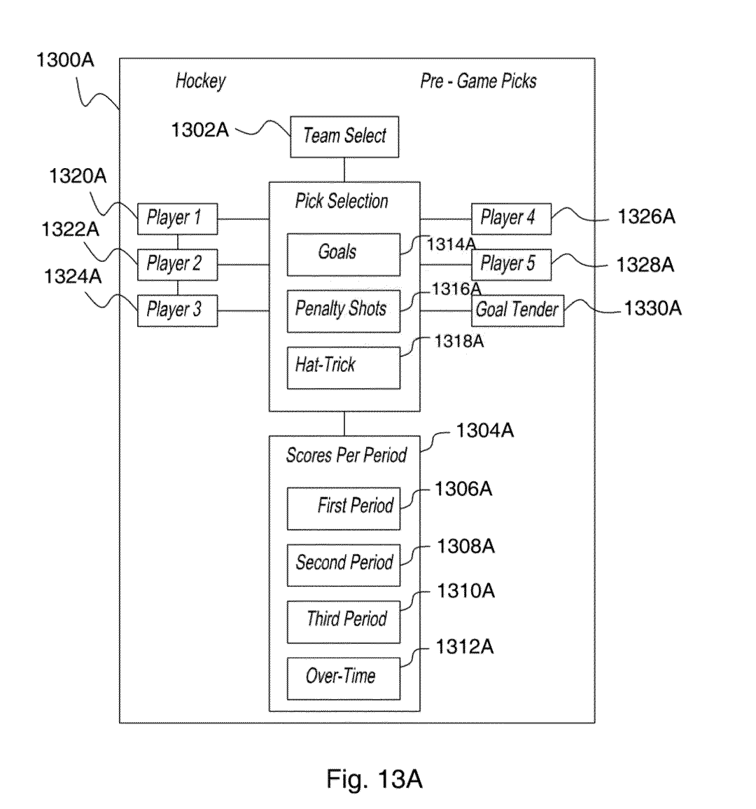

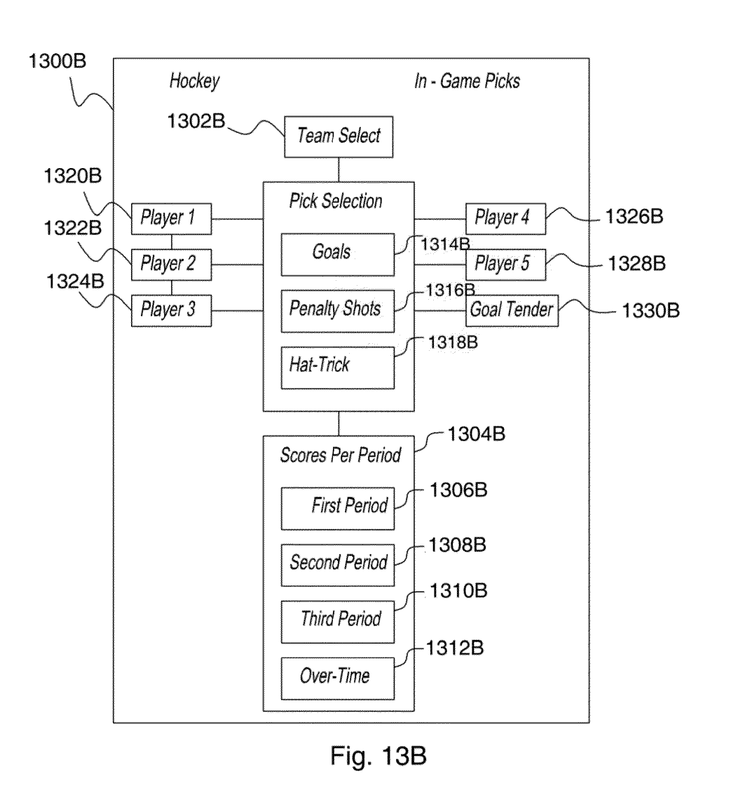

FIG. 13A is a simplified schematic illustration of another embodiment of a pre-game picks page 1300A depicting certain pre-game picks that users 102 (illustrated in FIG. 1A) may select in relation to a hockey game. In certain non-exclusive alternative embodiments, before a specifically selected hockey game, the users 102 may be allowed to make pre-game picks relating to: for non-goalies, the number of goals, assists, points, plus/minus, shots on goal, penalties and penalty minutes; and for goalies, the number of shots faced, saves, goals allowed and save percentage, during the course of the hockey game or during any specified portions of the hockey game. Certain pre-game picks may also relate to the same or similar statistics but for the entire team as opposed to individual players. Additionally and/or alternatively, the pre-game picks may relate to more or fewer statistics than those specifically listed above. Further, in some embodiments, the users 102 may also be able to make pre-game picks as to what the score will be at the end of the game as well as at the end of each of the periods of the game.

In the particular embodiment illustrated in FIG. 13A, the users 102 have the ability to make pre-game picks for each team 1302A regarding, but not limited to, the scores 1304A for each period 1306A-1312A (including overtime), the amount of goals 1314A, penalty shots 1316A, and hat-tricks 1316A by each player 1320A-1330A during the game. Users 102 are also able to decide which team 1302A will win or lose and/or predict the score at the end of the game.

FIG. 13B is a simplified schematic illustration of another embodiment of an in-game picks page 1300B depicting certain in-game picks that users 102 (illustrated in FIG. 1A) may select in relation to a hockey game. In certain non-exclusive alternative embodiments, during a specifically selected hockey game, the users 102 may be allowed to make in-game picks relating to: for non-goalies, the number of goals, assists, points, plus/minus, shots on goal, penalties and penalty minutes; and for goalies, the number of shots faced, saves, goals allowed and save percentage, during the course of the hockey game or during any specified portions of the hockey game. Certain in-game picks may also relate to the same or similar statistics but for the entire team as opposed to individual players. Additionally and/or alternatively, the in-game picks may relate to more or fewer statistics than those specifically listed above. Further, in some embodiments, the users 102 may also be able to make in-game picks as to what the score will be at the end of the game as well as at the end of each of the periods of the game.

In the particular embodiment illustrated in FIG. 138, the users 102 have the ability to make in-game picks for each team 1302B regarding, but not limited to, the scores 1304B for each period 1306B-1312B (including overtime), the amount of goals 1314B, penalty shots 1316B, and hat-tricks 1316B by each player 1320B-1330B during the game. Users 102 are also able to decide which team 1302B will win or lose and/or predict the score at the end of the game.

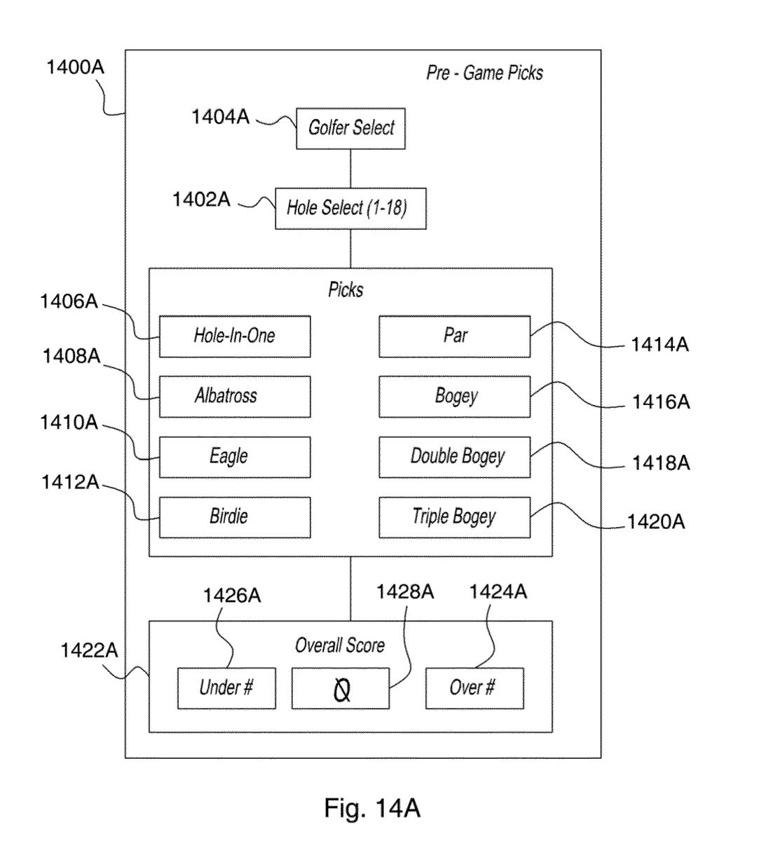

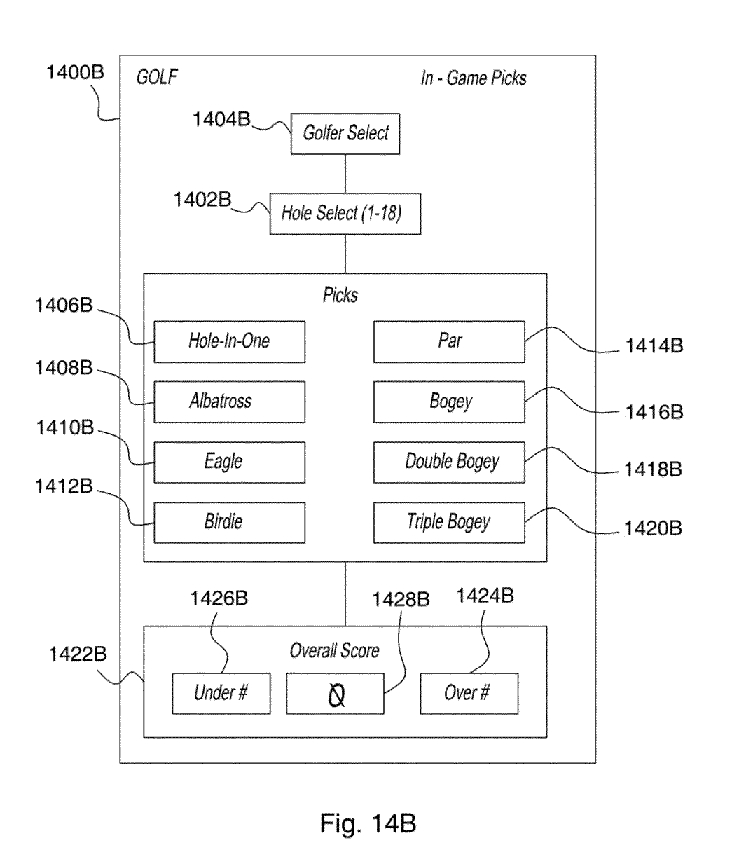

FIG. 14A is a simplified schematic illustration of another embodiment of a pre game (or pre-tournament or pre-round) picks page 1400A depicting certain pre-game (or pre-tournament or pre-round) picks that users 102 (illustrated in FIG. 1A) may select in relation to a golf tournament. In certain non-exclusive alternative embodiments, prior to a specifically selected golf tournament (or round), the users 102 may be able to make pre-tournament picks relating to the number of eagles, birdies, pars, bogeys, double bogeys, and others that any individual players may make during the course of a golf tournament and/or during the course of a round of golf during the tournament. Further, the users 102 may make pre-tournament picks as to what overall scores the individual players will have during the tournament and/or during any individual rounds of the tournament, what place individual players may finish in, as well as who may finish first, second, third, etc. in the tournament. Additionally and/or alternatively, the pre-tournament picks may relate to more or fewer statistics than those specifically listed above.

in the particular embodiment illustrated in FIG. 14A, the users 102 (illustrated in FIG. 1A) are allowed to make pre-tournament picks on every hole 1402A for each golfer 1404A in the tournament including, but not limited to, whether the golfer would get a hole-in-one 1406A, an albatross 1408A, an eagle 1410A, a birdie 1412A, a par 1414A, a bogey 1416A, a double bogey 1418A or triple bogey 1420A. Users 102 also have the ability to predict each golfer's overall score 1422A, and whether it be over par 1424A, under par 1426A, or even par 1428A.

FIG. 14B is a simplified schematic illustration of another embodiment of an in-game (or in-tournament or in-round) picks page 1400B depicting certain in-game (in-tournament or in-round) picks that users 102 (illustrated in FIG. 1A) may select in relation to a golf tournament. In certain non-exclusive alternative embodiments, during a specifically selected golf tournament (or round), the users 102 may be able to make in-tournament picks relating to the number of eagles, birdies, pars, bogeys, double bogeys, and others that any individual players may make during the course of a golf tournament and/or during the course of a round of golf during the tournament. Further, the users 102 may make in-tournament picks as to what overall scores the individual players will have during the tournament and/or during any individual rounds of the tournament, what place individual players may finish in, as well as who may finish first, second, third, etc. in the tournament. Additionally and/or alternatively, the in-tournament picks may relate to more or fewer statistics than those specifically listed above.

In the particular embodiment illustrated in FIG. 14B, the users 102 (illustrated in FIG. 1A) are allowed to make pre-tournament picks on every hole 1402B for each golfer 1404B in the tournament including, but not limited to, whether the golfer would get a hole-in-one 1406B, an albatross 1408B, an eagle 1410B, a birdie 1412B, a par 1414B, a bogey 1416B, a double bogey 1418B or triple bogey 1420B. Users 102 also have the ability to predict each golfer's overall score 1422B, and whether it be over par 1424B, under par 1426B, or even par 1428B.

The network system 100 (illustrated in FIG. 1) and application 110 (illustrated in FIG. 1) as described herein can also be used in conjunction with additional sporting events. For example, for use in relation to a boxing match, one embodiment of the network system 100 and application 110 allows the user 102 (illustrated in FIG. 1A) to make pre-fight picks on the number of jabs each boxer will land, the number of power punches each boxer will land, the number of knockdowns each boxer will score, and whether a boxer will win by knockout or decision. If the match ends by knockout, the user 102 may make pre-fight picks as to which round the knockout will occur. If the match goes to a decision, the user 102 may make pre-fight picks as to how many points each boxer will accumulate per round and overall throughout the fight, as well as whether the decision will be a unanimous, split, or majority decision. The user 102 may also make pre-fight picks as to whether a fight will end in a draw, no contest, disqualification, or by a technical decision. In the case of a draw, the user 102 may make pre-fight picks as to whether the draw will be unanimous, split, or majority. In the case of a disqualification, no contest, or technical decision, the user 102 may make pre-fight predictions as to the round in which the match-ending foul will occur.

Additionally, also for use in relation to a boxing match, in one embodiment, the user 102 may make in-fight picks on the number of jabs each boxer will land, the number of power punches each boxer will land, the number of knockdowns each boxer will score, and whether a boxer will win by knockout or decision. If the match ends by knockout, the user 102 may make in-fight picks as to which round the knockout will occur. If the match goes to a decision, the user 102 may make in-fight picks as to how many points each boxer will accumulate, as well as whether the decision will be a unanimous, split, or majority decision. The user 102 may also make in-fight picks as to whether a fight will end in a draw, no contest, disqualification, or by a technical decision. In the case of a draw, the user 102 may make in-fight picks as to whether the draw will be unanimous, split, or majority. In the case of a disqualification, no contest, or technical decision, the user 102 may make in-fight predictions as to the round in which the match-ending foul will occur.

Further, for use in relation to a mixed martial arts match, one embodiment of the network system 100 and application 110 allows the user 102 to make pre-fight picks on the number of standing strikes each fighter will land, the number of ground strikes each fighter will land, the number of takedowns each fighter will secure, the number of knockdowns each fighter will score, the number of submissions each fighter will attempt, and whether a fighter will win by knockout, submission, or decision. If the match ends by knockout or submission, the user 102 may make pre-fight picks as to which round the knockout or submission will occur. In addition, if the fight ends by submission, the user 102 may make pre-fight picks as to which submission the winning fighter will use. If the match goes to a decision, the user 102 may make pre-fight picks as to how many points each fighter will accumulate, as well as whether the decision will be a unanimous, split, or majority decision. The user 102 may also make pre-fight picks as to whether a fight will end in a draw, no contest, disqualification, or by a technical decision. In the case of a draw, the user 102 may make pre-fight picks as to whether the draw will be unanimous, split, or majority. In the case of a disqualification, no contest, or technical decision, the user 102 may make pre-fight predictions as to the round in which the match-ending foul will occur.

Additionally, also for use in relation to a mixed martial arts match, in one embodiment, the user 102 may make in-fight picks on the number of standing strikes each fighter will land, the number of ground strikes each fighter will land, the number of takedowns each fighter will secure, the number of knockdowns each fighter will score, the number of submissions each fighter will attempt, and whether a fighter will win by knockout, submission, or decision. If the match ends by knockout or submission, the user 102 may make in-fight picks as to which round the knockout or submission will occur. In addition, if the fight ends by submission, the user 102 may make in-fight picks as to which submission the winning fighter will use. If the match goes to a decision, the user 102 may make in-fight picks as to how many points each fighter will accumulate, as well as whether the decision will be a unanimous, split, or majority decision. The user 102 may also make in-fight picks as to whether a fight will end by a draw, no contest, disqualification, or by a technical decision. In the case of a draw, the user 102 may make in-fight picks as to whether the draw will be unanimous, split, or majority. In the case of a disqualification, no contest, or technical decision, the user 102 may make in-fight predictions as to the round in which the match-ending foul will occur.

In another embodiment, i.e. for racing event users (i.e. stock car, Formula One, etc.), the network system 100 and application 110 allows the user 102 to make pre-race picks on the order of placers in the race. In addition, if a driver is forced to leave the race, the user 102 may make pre-race picks as to what lap the driver will leave the race. Moreover, in one embodiment, the user 102 may make in-race picks on the order of placers in the race. In addition, if a driver is forced to leave the race, the user 102 may make in-race picks as to what lap the driver will leave the race.

Further, for tennis event users, one embodiment of the network system 100 and application 110 allows the user 102 to make pre-match picks as to the score of each game, the winner of each game, the score of each set, the winner of each set, and the winner of the match. Users 102 will also be able to pick the number of aces, double faults, backhand winners, forehand winners or unforced errors totaled during the match or by certain players. The aforementioned embodiment can be applicable to both singles and doubles matches. Additionally, in one embodiment, the user 102 may make in-match picks as to the score of each game, the winner of each game, the score of each set, the winner of each set, and the winner of the match. Users 102 will also be able to pick the number of aces, double faults, backhands winners, forehand winners or unforced errors totaled during the match or by certain players. The aforementioned embodiment can be applicable to both singles and doubles matches.

Still further, for horse racing event users, one embodiment of the system and method allows the user 102 to make pre-race picks as to the winner of each race along with the distance by which each winner wins his race. In addition, if a jockey/horse is forced to leave the race, the user 102 may make pre-race picks as to how far from the finish the horse leaves the race. Moreover, in one embodiment, the user 102 may make in-race picks as to the winner of each race along with the distance by which each winner wins his race. In addition, if a jockey/horse is forced to leave the race, the user 102 may make in-race picks as to how far from the finish the horse leaves the race.

For all sports or entertainment events, the network system 100 and application 110 can also be used for interactive trivia games allowing for all users 102 to participate. Trivia can relate to event-specific questions, players or entertainer questions, or general questions concerning the history of a sport or other type of entertainment. Simplified trivia questions can also be incorporated into the children's version of the application. Results and answers for trivia questions can be displayed through the input devices 108 of the users 102.

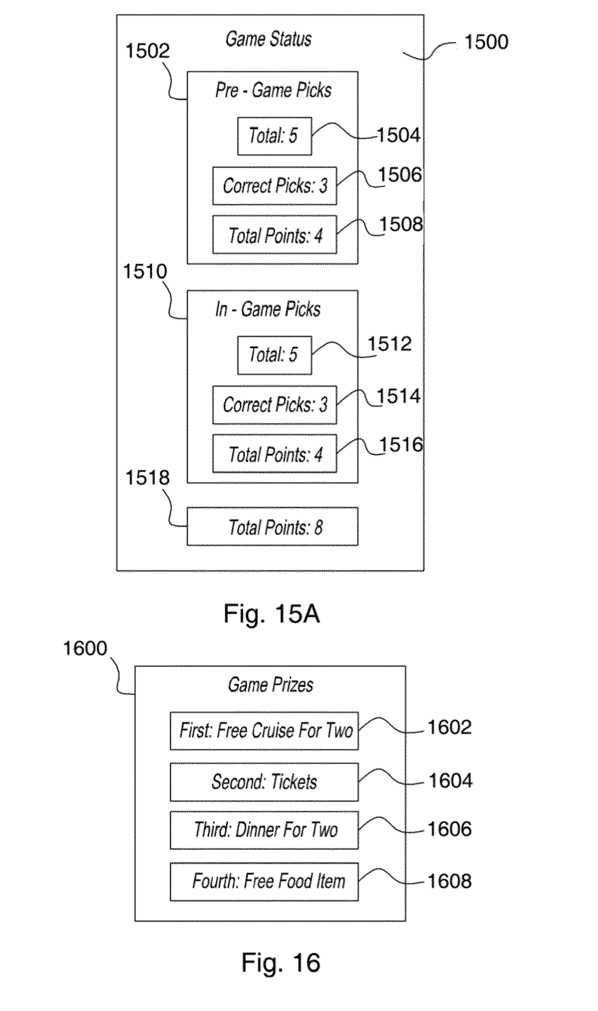

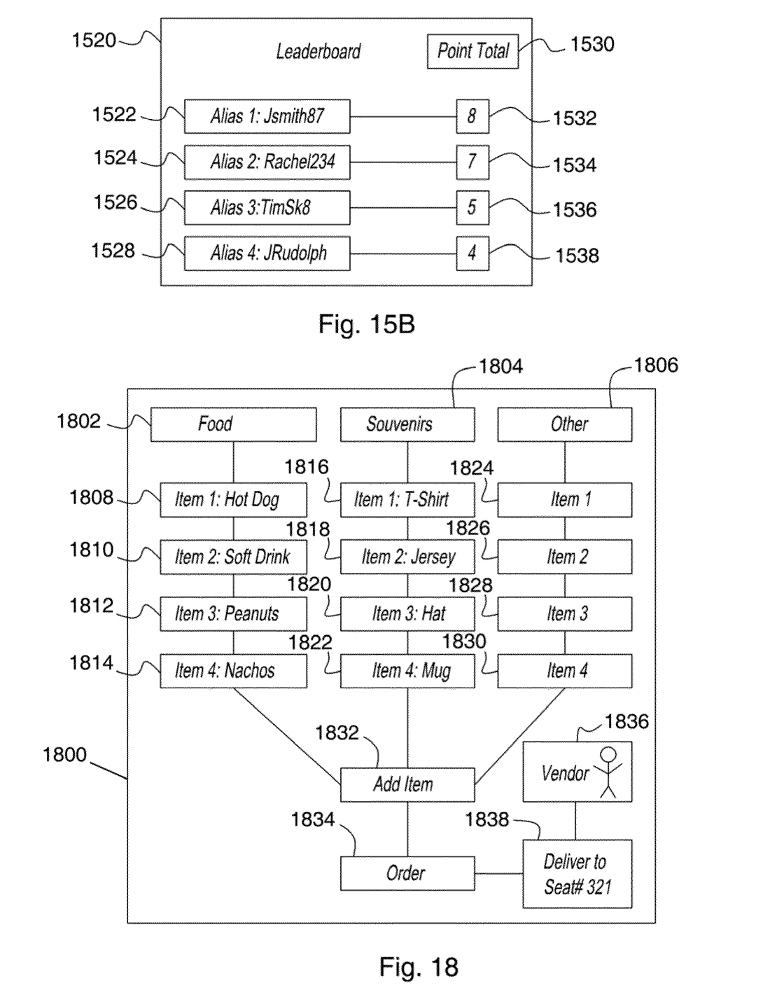

FIG. 15A is a simplified schematic illustration of an embodiment of a viewable “Game Status” interface 1500. In particular, FIG. 15A is a diagram of one embodiment that depicts the game status of the ongoing competition between users 102 (illustrated in FIG. 1A) by providing the users 102 with a breakdown of several user statistics. In certain embodiments, the game status interface 1500 menu may contain the stadium information, the teams, date, time and remaining time until start of the sporting event. Further, each section has an action assigned to it, which allows the users 102 to get more information on the given item (e.g., the biography of a player on a team, with photos). In addition, the game status interface 1500 may further include a progress meter, e.g., a green progress meter at the bottom, which shows the time remaining until the start of the sporting event. As illustrated in FIG. 15A, the game status interface 1500 can provide user-based pre-game statistics 1502 including, but not limited to, the number of pre-game picks made 1504, the correctly made 1506 pre-game picks, and the total points 1508 allocated based on the correct pre-game picks that were made. Additionally, the users 102 also have the ability to view their in-game statistics 1510, which can include, but are not limited to, the number of in-game picks made 1512, the correctly made 1514 in-game picks, and the total points 1516 allocated based on the correct in-game picks that were made. All of these points 1508, 1516 are then totaled to give the user 102 an overall points score 1518 for the individual competition.

FIG. 15B is a simplified schematic illustration depicting a leaderboard interface 1520 for displaying the current standings or rankings of the users 102 (illustrated in FIG. 1A). In particular, the leaderboard interface 1520 can include a standings screen that contains the cumulative overall standings spanned throughout the users 102 participating in the game. Since each pick is awarded points or other benefits (or less or no points or benefits if the pick was incorrect) the leaderboard interface 1520 can provide a positional chart for all of the users 102 in a given competition. The leaderboard interface 1520 can also show what position the given user 102 is in, e.g., at the bottom of the screen. One can also search for a given position by entering it on a search bar that may be provided within the leaderboard interface 1520. In one embodiment, the format of the packet can be the same throughout the network system 100 (illustrated in FIG. 1A), with JSON encoded maps which are then converted to associative arrays on the server side. For example, FIG. 158 shows a diagram of the standings screen that allows for the users 102 to view a “Leaderboard” depicting each of the top competitors 1522-1528 participating in the competition, along with their alias, and the respective ranking of each of the top competitors 1522-1528 based on the number of points that have been awarded to each of the competitors 1522-1528 at that time for that particular sporting event. More specifically, the leaderboard interface 1520 can provide the number of points 1530 that have been awarded to the particular user 102 viewing the leaderboard interface 1520, as well as the number of points 1532-1538 that have been awarded to each of the top competitors 1522-1528 in the competition. Depending on the number of correctly made pre-game and/or in-game picks by each of the competitors 1522-1528, the network system 100 and application 110 (illustrated in FIG. 1A) can calculate the proper number of points and automatically rank the top competitors 1522-1528 on the leaderboard interface 1520 along with the other participating users 102. The leaderboard interlace 1520 can also display each users' overall ranking against all others that use this same system and method described in this present disclosure. This gives the user 102 the opportunity to compare their own performance against friends, family, and all other past and present users 102.

In certain embodiments, the network system 100 and application 110 can further include means for the various users 102 to view (i) the number of points the users 102 can earn upon making accurate predicted outcomes and/or answering one or more questions correctly; (ii) the total number of points the user 102 has accumulated and the corresponding prizes, e.g., free game tickets for upcoming games or the ability to meet certain players, that the user 102 can claim after having accumulated a certain number of points; and (iii) a high scorers list that shows the top overall score for different competitions related to the same sport, which may encourage and motivate the users 102 to play more and reach to the highest scorers list.

FIG. 16 is a simplified schematic illustration depicting an embodiment of a game prizes interface 1600 showing the viewable game prizes that may be won by any participating user 102 (illustrated in FIG. 1A) or viewer. In particular, FIG. 16 shows a diagram of one non-exclusive example of a game prizes menu, which shows the specific prizes that are available in association with the specific competition between the users 102. For example, as illustrated in this embodiment, the game prizes interface 1600 can provide a listing of the available game prizes to be won for first place 1602, second place 1604, third place 1606 and fourth place 1608 participants in the competition. Additionally and/or alternatively, the game prizes interface 1600 can show more or fewer place prizes. The applicable game prizes may include, but are not limited to: tickets to future games, opportunities to meet players, complimentary food and/or souvenir items, coupons, vacation getaway packages, and gift cards cash, prizes, discounts, coupons, incentives, tickets, targeted advertising, or promotional materials. Such content can be retrieved from the game application 110 (illustrated in FIG. 1A) along with images related to such game prizes. In one embodiment, images are retrieved using GET commands bundled with the authentication token and DeviceID in order to avoid illegal exploitation.

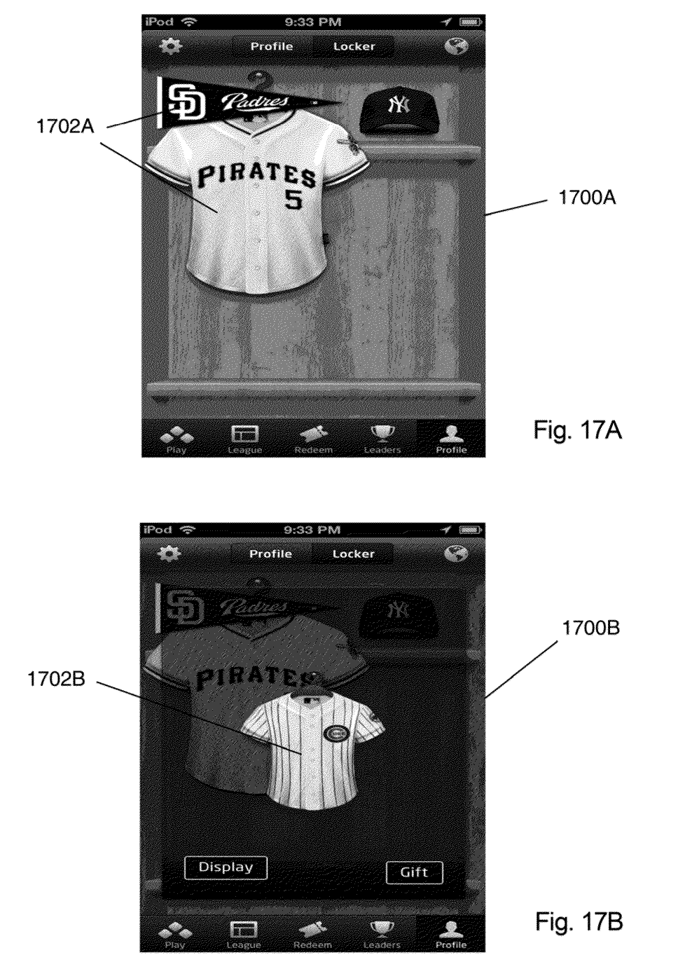

Additionally, as noted above, in certain embodiments, the prizes and/or awards that are available as a result of participating in competitions via the application 110 can include items such as virtual souvenirs, cash, trips, gift cards, coupons, and the like. For example, FIG. 17A is a simplified screen shot of an embodiment of a virtual locker 1700A that can be incorporated within the network system 100 and application 110 of FIG. 1A. In some embodiments, during the use of the network system 100 and application 110, each user 102 can have a virtual locker 1700A, and as virtual souvenirs 1702A, e.g., caps, jerseys, pennants, etc. are awarded, the users 102 are then able to display such virtual souvenirs 1702A in their virtual lockers 1700A. Additionally, in one embodiment, the users 102 can also use their virtual cash (or actual cash) and/or points that have been awarded during competitions to purchase any such virtual souvenirs 1702A for purposes of displaying such virtual souvenirs 1702A in their virtual lockers 1700A. With this design, the users 102 can display their virtual souvenirs 1702A, as desired, where friends, family, and others may be able to view such goods that have been acquired by the user 102.

It should be noted that certain of the virtual souvenirs 1702A may be more rare, and thus more difficult to acquire. For example, certain such virtual souvenirs 1702A may require higher amounts of points or cash (virtual or actual) or may only be awarded in larger competitions.

FIG. 17B is a simplified screen shot of another embodiment of a virtual locker 1700B that can be incorporated within the network system and method of FIG. 1A. More particularly, FIG. 17B illustrates that, in one embodiment, when any given user 102 (illustrated in FIG. 1A) may be receiving and/or purchasing any virtual souvenirs 1702B, the user 102 can decide whether they want to display the virtual souvenirs 1702B within their virtual locker 1700B or gift the virtual souvenirs 1702B to one or more other users 102, e.g., friends or family.

FIG. 18 is a simplified schematic illustration of an order interface 1800 which gives users 102 (illustrated in FIG. 1A), e.g., actual attendees at a sporting event, the ability to order food 1802, souvenirs 1804, and other items 1806 from their seat using the present invention. For example, FIG. 18 illustrates that actual attendees at a sporting event may be able to request and purchase certain specific food items 1808-1814, souvenirs 1816-1822, and other items 1824-1830 without having to leave their seats. It should be noted that the specific food items and/or souvenirs that may be available to the actual attendees can be different than those specifically shown in FIG. 18. Moreover, in certain embodiments, the users 102 may be able to add items 1832 that are not otherwise specifically listed on the order interface 1800.

Once the actual attendee user 102 has selected the order 1834, the system and method provides the vendor 1836 with the attendee's seat 1838 to which the ordered items are to be delivered. For example, if an attendee attending a baseball game desires a bag of peanuts, the attendee may select “Order” 1834 from the menu screen and make an order for one of the available items (e.g., peanuts) to be delivered to the attendee's seat. This will bring about an overall benefit for both the attendees 102 and the stadium. Without having to get up and wait in lines or until the vendor 1836 has come around to that particular section of the stadium, the attendees 102 will feel more willing to make purchases while being immediately satisfied and never having to miss a minute of the game. This better serves the stadium because not only will sales go up due to more attendees 102 being willing to make purchases, but vendors 1836 will have a more efficient method of knowing who is in need of a purchasable item for sale and thus able to sell more items during the course of the sporting event.

While a number of exemplary aspects and embodiments of a network system 100, network 106 and application 110 have been discussed herein, those skilled in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for providing a game, the method comprising the steps of:
communicating a first predicted outcome of a future occurrence within a sporting event to a network via a first input device, the first predicted outcome being determined by a first user; and
once the future occurrence has occurred, communicating an actual outcome of the occurrence from the network to the first input device.

2. The method of claim 1 wherein the step of communicating the actual outcome of the occurrence occurs substantially concurrently with the actual outcome of the occurrence.

3. The method of claim 1 further comprising the step of evaluating the accuracy of the first predicted outcome with the network by comparing the first predicted outcome with the actual outcome.

4. The method of claim 3 further comprising the step of communicating information regarding the accuracy of the first predicted outcome to the first input device with the network.

5. The method of claim 3 further comprising the step of awarding benefits to the first user based on the accuracy of the first predicted outcome.

6. The method of claim 5 wherein the step of awarding benefits includes awarding points to the first user based on the accuracy of the first predicted outcome for use in a competition against a second user.

7. The method of claim 6 wherein the first user and the second user are actual attendees at the sporting event.

8. The method of claim 5 wherein the step of awarding benefits includes correlating the benefits to be awarded to actuarial data regarding the probability that the first predicted outcome will occur.

9. The method of claim 1 wherein the first predicted outcome relates to an individual occurrence during the course of the sporting event.

10. The method of claim 9 wherein the individual occurrence is a pitch during a baseball game, and wherein the first predicted outcome includes one of a location, a type and a speed of the pitch.

11. The method of claim 1 further comprising the step of the network querying the first user via the first input device regarding the future occurrence prior to the step of communicating the first predicted outcome that is determined by the first user to the network via the first input device.

12. The method of claim 1 wherein the first input device is one of a mobile phone, a tablet, a laptop computer, a kiosk and a desktop computer.

13. A method for providing a game, the method comprising the steps of:
communicating a first predicted outcome that is determined by a first user to a network via a first input device, the first predicted outcome relating to a future occurrence during a sporting event;
once the future occurrence has occurred, evaluating the accuracy of the first predicted outcome with the network by comparing the first predicted outcome with an actual outcome of the occurrence; and
awarding benefits to the first user via the network based on the accuracy of the first predicted outcome.

14. The method of claim 13 wherein the step of evaluating includes evaluating the accuracy of the first predicted outcome with the network substantially concurrently with the actual outcome of the occurrence.

15. The method of claim 13 further comprising the step of communicating information regarding the accuracy of the first predicted outcome from the network to the first input device.

16. The method of claim 13 wherein the step of awarding benefits includes awarding points to the first user based on the accuracy of the first predicted outcome for use in a competition against a second user.

17. The method of claim 13 wherein the step of awarding benefits includes correlating the benefits to be awarded to actuarial data regarding the probability that the first predicted outcome will occur.

18. The method of claim 13 wherein the first predicted outcome relates to an individual occurrence during the course of the event.

19. The method of claim 18 wherein the individual occurrence is a pitch during a baseball game, and wherein the first predicted outcome includes one of a location, a type and a speed of the pitch.

20. The method of claim 13 further comprising the step of the network querying the first user via the first input device with respect to the future occurrence prior to the step of communicating the first predicted outcome that is determined by the first user to the network via the first input device.

21. A method for providing a game, the method comprising the steps of:
querying a first user with respect to a future occurrence in a sporting event via a first input device with a network;
communicating a first predicted outcome that is determined by the first user to the network via the first input device, the first predicted outcome relating to the future occurrence in the sporting event;
once the future occurrence has occurred, communicating an actual outcome of the occurrence from the network to the first input device substantially concurrently with the actual outcome of the occurrence;
evaluating the accuracy of the first predicted outcome with the network by comparing the first predicted outcome with the actual outcome of the occurrence;
communicating information regarding the accuracy of the first predicted outcome from the network to the first input device; and
awarding points to the first user via the network based on the accuracy of the first predicted outcome.
